(19) United States
(12) Patent Application Publication
(10) Pub. No.: US 2024/0414738 A1
(43) Pub. Date: Dec. 12, 2024

(54) Method and Apparatus for Carrier Aggregation

(71) Applicant: Telefonaktiebolaget LM Ericsson (publ), Stockholm (SE)

(72) Inventors: Min Wang, Luleå (SE); Zhang Zhang, Beijing (CN)

(21) Appl. No.: 18/696,737

(22) PCT Filed: Oct. 28, 2022
(86) PCT No.: PCT/CN2022/128298

§ 371 Date: Mar. 28, 2024

(30) Foreign Application Priority Data
Oct. 28, 2021 (WO) PCT/CN2021/127141

(51) Int. Cl. H04W 72/25; H04L 1/1607; H04W 76/38

(52) U.S. Cl. CPC H04W 72/25; H04L 1/1614; H04W 76/38

(57) ABSTRACT

Various embodiments of the present disclosure provide a method for carrier aggregation. The method which may be performed by a user equipment comprises: receiving, from a base station, a first indication of activating or deactivating a sidelink carrier configured for the user equipment. In accordance with an exemplary embodiment, the method further comprises: determining whether to activate or deactivate the sidelink carrier, according to the first indication. In accordance with another exemplary embodiment, the method further comprises: transmitting a second indication of activating or deactivating the SL carrier to one or more other UEs which are configured with the SL carrier.

### FIELD OF THE INVENTION

The present disclosure generally relates to communication networks, and more specifically, to a method and apparatus for carrier aggregation (CA).

### BACKGROUND

This section introduces aspects that may facilitate a better understanding of the disclosure. Accordingly, the statements of this section are to be read in this light and are not to be understood as admissions about what is in the prior art or what is not in the prior art.

Communication service providers and network operators have been continually facing challenges to deliver value and convenience to consumers by, for example, providing compelling network services and performance. With the evolution of wireless communication, a requirement for supporting device-to-device (D2D) communication features in various applications is proposed. An extension for the D2D work may consist of supporting vehicle-to-everything (V2X) communication, which may include any combination of direct communications among vehicles, pedestrians and infrastructure. Wireless communication networks such as fourth generation (4G)/long term evolution (LTE) and fifth generation (5G)/new radio (NR) networks may be expected to use V2X services and support communication for V2X capable user equipment (UE).

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

D2D communications (also referred to as sidelink (SL) communications or communications over PC5 interface) between neighboring devices are specified by the 3rd generation partnership project (3GPP) in Release-12 (Rel-12). Some enhancements of the SL are introduced in subsequent releases for vehicle-to-vehicle (V2V) or V2X communications. In a wireless communication network supporting SL communications, a V2X capable UE may act as a relay UE which can provide the functionality to support connectivity to the network for another UE that may be out of cell coverage and may not be able to connect with the network directly. In some cases, a UE may communicate with another UE directly or via one or more relay UEs.

Carrier aggregation (CA) is a technique that may be used in wireless communication to increase the bandwidth, and thereby increase the bitrate. Each aggregated carrier may be referred to as a component carrier (CC). When CA is used, a UE may be configured with a number of serving cells, e.g., including a primary cell (PCell) and one or more secondary cells (SCells), one for each component carrier. The coverage of the serving cells may differ, for example due to that CCs on different frequency bands may experience different pathloss. The SCells may be activated or deactivated as required. For example, a base station may send signaling over Uu interface to activate or deactivate an SCell for a UE. However, there is no existing solutions for activating or deactivating SL carriers in case of CA. The signaling for CA in Uu may not be used for a SL UE in CA, especially when the SL UE is out of network coverage. In addition, since a SL radio bearer (RB) is directional, which is different from a Uu RB, the mechanism for activating or deactivating a carrier in Uu may not be applicable to a SL UE in CA. Therefore, it may be desirable to implement activation or deactivation of a SL carrier in a more efficient way.

Various exemplary embodiments of the present disclosure propose a solution for CA, which may enable a base station or a UE to activate or deactivate a SL carrier in the case of CA.

It can be appreciated that a link or a radio link over which signals are transmitted between at least two UEs for D2D operations may be called in this document as the sidelink (SL). The signals transmitted between the UEs for D2D operations may be called in this document as SL signals. The terms “sidelink” and “SL” may also interchangeably be called as D2D link, V2X link, ProSe link, peer-to-peer link, PC5 link, etc. The SL signals may also interchangeably be called as V2X signals, D2D signals, ProSe signals, PC5 signals, peer-to-peer signals, etc.

According to a first aspect of the present disclosure, there is provided a method performed by a UE. The method comprises: receiving, from a base station, a first indication of activating or deactivating a SL carrier configured for the UE. In accordance with an exemplary embodiment, the method further comprises: determining whether to activate or deactivate the SL carrier, according to the first indication.

In accordance with an exemplary embodiment, the method according to the first aspect of the present disclosure may further comprise: transmitting a second indication of activating or deactivating the SL carrier to one or more other UEs which are configured with the SL carrier.

In accordance with an exemplary embodiment, the first indication may comprise one or more of the following information:
an identifier of the SL carrier;
an indicator which indicates that the SL carrier needs to be activated or deactivated;
one or more destination identifiers associated with the SL carrier; and
one or more factors, wherein when the one or more factors are satisfied, the SL carrier needs to be activated or deactivated.

In accordance with an exemplary embodiment, the one or more factors may comprise one or more of:
a time threshold indicating a time period during which the SL carrier needs to be deactivated;
a buffer threshold above which the SL carrier needs to be activated;
timing of activating the SL carrier; and
timing of deactivating the SL carrier.

In accordance with an exemplary embodiment, the indicator which indicates that the SL carrier needs to be activated or deactivated may be a bit associated with the SL carrier in a bitmap.

In accordance with an exemplary embodiment, the UE may determine whether to activate or deactivate the SL carrier, based at least in part on the one or more factors.

In accordance with an exemplary embodiment, when the UE determines to activate the SL carrier, the method according to the first aspect of the present disclosure may further comprise: activating the SL carrier according to the first indication.

In accordance with an exemplary embodiment, when the UE determines to deactivate the SL carrier, the method according to the first aspect of the present disclosure may further comprise: deactivating the SL carrier according to the first indication.

In accordance with an exemplary embodiment, the deactivation of the SL carrier may comprise one or more of:
clearing any mode 2 SL grant associated with the SL carrier;
stopping sensing on the SL carrier if the UE adopts mode 2 resource allocation;
stopping SL transmission on the SL carrier; and
stopping SL reception on the SL carrier.

In accordance with an exemplary embodiment, the SL carrier may be activated or deactivated according to timing information which may be determined based at least in part on the first indication.

In accordance with an exemplary embodiment, the second indication may comprise: an identifier of the SL carrier, and/or an indicator which indicates that the SL carrier needs to be activated or deactivated, etc.

In accordance with an exemplary embodiment, the one or more other UEs may be associated with one or more destination identifiers which are associated with the SL carrier and indicated by the first indication.

In accordance with an exemplary embodiment, the method according to the first aspect of the present disclosure may further comprise: receiving, from at least one of the one or more other UEs, an acknowledgement indicating that the second indication is received by the at least one of the one or more other UEs. Alternatively or additionally, the method according to the first aspect of the present disclosure may further comprise: receiving, from at least one of the one or more other UEs, a message indicating that the at least one of the one or more other UEs accepts or rejects the activation or the deactivation of the SL carrier.

In accordance with an exemplary embodiment, the activation or the deactivation of the SL carrier may be performed by the UE when receiving, from at least one of the one or more other UEs, an acknowledgement indicating that the second indication is received by the at least one of the one or more other UEs. Alternatively or additionally, the activation or the deactivation of the SL carrier may be performed by the UE when receiving, from at least one of the one or more other UEs, a message indicating that the at least one of the one or more other UEs accepts the activation or the deactivation of the SL carrier.

In accordance with an exemplary embodiment, the activation or the deactivation of the SL carrier may be applicable for a direction from the UE to a peer UE of the UE.

In accordance with an exemplary embodiment, the method according to the first aspect of the present disclosure may further comprise: transmitting information about the SL carrier to the base station and/or a peer UE of the UE. In an embodiment, the information about the SL carrier may be used by the base station and/or the peer UE of the UE to determine whether to activate or deactivate the SL carrier.

In accordance with an exemplary embodiment, the transmission of the information about the SL carrier may be performed by the UE in one or more of the following ways:
periodically;
event triggered;
upon reception of a request from the peer UE of the UE; and
upon reception of signaling from the base station.

In accordance with an exemplary embodiment, the information about the SL carrier may comprise one or more of:
buffer status for all services or for one or more services which are mapped to the SL carrier;
buffer status of current data;
buffer status of future data which is expected to come;
resource status of the SL carrier;
channel measurement information; and
a preference of power saving.

In accordance with an exemplary embodiment, the method according to the first aspect of the present disclosure may further comprise: receiving information about the SL carrier from a peer UE of the UE. In an embodiment, the information about the SL carrier may be used by the UE to determine whether to activate or deactivate the SL carrier.

In accordance with an exemplary embodiment, when the UE is configured with a timer for the SL carrier, the method according to the first aspect of the present disclosure may further comprise performing one or more of the following actions:
starting the timer upon the activation of the SL carrier;
restarting the timer in response to one or more events;
starting to deactivate the SL carrier when the timer is expired; and
stopping the timer when the UE starts to deactivate the SL carrier.

In accordance with an exemplary embodiment, the one or more events may comprise one or more of:
reception of downlink control information (DCI) indicating one or more SL grants for the SL carrier by the UE;
transmission of a medium access control (MAC) protocol data unit (PDU), on the SL carrier by the UE in a configured SL grant;
transmission of sidelink control information (SCI) on the SL carrier after the UE obtains a SL grant; and
reception of SCI on the SL carrier by the UE indicating a coming reception from a peer UE of the UE.

In accordance with an exemplary embodiment, the activation or the deactivation of the SL carrier may be applicable for transmission on the SL carrier, or for reception on the SL carrier, or for both.

According to a second aspect of the present disclosure, there is provided an apparatus which may be implemented as a UE. The apparatus may comprise one or more processors and one or more memories storing computer program codes. The one or more memories and the computer program codes may be configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus which may be implemented as a UE. The apparatus may comprise a receiving unit and a determining unit. In accordance with some exemplary embodiments, the receiving unit may be operable to carry out at least the receiving step of the method according to the first aspect of the present disclosure. The determining unit may be operable to carry out at least the determining step of the method according to the first aspect of the present disclosure.

According to a fifth aspect of the present disclosure, there is provided a method performed by a base station. The method comprises: determining a first indication of activating or deactivating a SL carrier configured for a UE. In accordance with an exemplary embodiment, the method further comprises: transmitting the first indication to the UE. In an embodiment, the UE may be able to transmit a second indication (e.g., the second indication as described according to the first aspect of the present disclosure) of activating or deactivating the SL carrier to one or more other UEs which are configured with the SL carrier.

In accordance with an exemplary embodiment, the first indication transmitted by the base station according to the fifth aspect of the present disclosure may correspond to the first indication received by the UE according to the first aspect of the present disclosure. Thus, the first indication as described according to the first and fifth aspects of the present disclosure may have the same or similar contents and/or feature elements.

In accordance with an exemplary embodiment, the method according to the fifth aspect of the present disclosure may further comprise: receiving, from a peer UE of the UE, a notification of that the SL carrier is to be activated or deactivated.

In accordance with an exemplary embodiment, the method according to the fifth aspect of the present disclosure may further comprise: transmitting, to the peer UE of the UE, an instruction of accepting or rejecting the activation or the deactivation of the SL carrier.

In accordance with an exemplary embodiment, the peer UE of the UE may be associated with a destination identifier which is associated with the SL carrier and indicated by the first indication.

In accordance with an exemplary embodiment, the method according to the fifth aspect of the present disclosure may further comprise: receiving information about the SL carrier from the UE. In an embodiment, the information about the SL carrier may be used by the base station to determine whether to activate or deactivate the SL carrier.

In accordance with an exemplary embodiment, the information about the SL carrier received by the base station according to the fifth aspect of the present disclosure may correspond to the information about the SL carrier transmitted by the UE according to the first aspect of the present disclosure. Thus, the information about the SL carrier as described according to the first and fifth aspects of the present disclosure may have the same or similar contents and/or feature elements.

In accordance with an exemplary embodiment, the method according to the fifth aspect of the present disclosure may further comprise: exchanging information with one or more other base stations to determine whether to activate or deactivate the SL carrier.

According to a sixth aspect of the present disclosure, there is provided an apparatus which may be implemented as a base station. The apparatus may comprise one or more processors and one or more memories storing computer program codes. The one or more memories and the computer program codes may be configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus which may be implemented as a base station. The apparatus may comprise a determining unit and a transmitting unit. In accordance with some exemplary embodiments, the determining unit may be operable to carry out at least the determining step of the method according to the fifth aspect of the present disclosure. The transmitting unit may be operable to carry out at least the transmitting step of the method according to the fifth aspect of the present disclosure.

According to a ninth aspect of the present disclosure, there is provided a method performed by a UE. The method comprises: determining whether to activate or deactivate a SL carrier configured for the UE. In accordance with an exemplary embodiment, the method further comprises: performing one or more actions according to a result of the determination.

In accordance with an exemplary embodiment, the one or more actions may comprise: generating a second indication of activating or deactivating the SL carrier.

In accordance with an exemplary embodiment, the one or more actions may further comprise: transmitting the second indication to one or more other UEs which are configured with the SL carrier.

In accordance with an exemplary embodiment, the determination of whether to activate or deactivate the SL carrier may be made by the UE itself, without receiving a first indication (e.g., the first indication as described with respect to the first aspect of the present disclosure) of activating or deactivating the SL carrier from a base station.

In accordance with an exemplary embodiment, the one or more actions may comprise: activating or deactivating the SL carrier, according to timing information determined by the UE.

In accordance with an exemplary embodiment, the deactivation of the SL carrier may comprise: clearing any mode 2 SL grant associated with the SL carrier; stopping sensing on the SL carrier if the UE adopts mode 2 resource allocation; stopping SL transmission on the SL carrier; and/or stopping SL reception on the SL carrier, etc.

In accordance with an exemplary embodiment, the second indication may comprise: an identifier of the SL carrier; and/or an indicator which indicates that the SL carrier needs to be activated or deactivated, etc.

In accordance with an exemplary embodiment, the indicator which indicates that the SL carrier needs to be activated or deactivated may be a bit associated with the SL carrier in a bitmap.

In accordance with an exemplary embodiment, the one or more other UEs may be associated with one or more destination identifiers which are associated with the SL carrier and determined by the UE.

In accordance with an exemplary embodiment, the one or more actions may further comprise receiving from at least one of the one or more other UEs: an acknowledgement indicating that the second indication is received by the at least one of the one or more other UEs; and/or a message indicating that the at least one of the one or more other UEs accepts or rejects the activation or the deactivation of the SL carrier, etc.

In accordance with an exemplary embodiment, the activation or the deactivation of the SL carrier may be performed by the UE when receiving, from at least one of the one or more other UEs: an acknowledgement indicating that the second indication is received by the at least one of the one or more other UEs; and/or a message indicating that the at least one of the one or more other UEs accepts the activation or the deactivation of the SL carrier, etc.

In accordance with an exemplary embodiment, the activation or the deactivation of the SL carrier may be applicable for a direction from the UE to a peer UE of the UE.

In accordance with an exemplary embodiment, the method according to the ninth aspect of the present disclosure may further comprise: transmitting information about the SL carrier to a base station and/or a peer UE of the UE. In an embodiment, the information about the SL carrier may be used by the base station and/or the peer UE of the UE to determine whether to activate or deactivate the SL carrier.

In accordance with an exemplary embodiment, the transmission of the information about the SL carrier may be performed by the UE in at least one of the following ways:
periodically;
event triggered;
upon reception of a request from the peer UE of the UE; and
upon reception of signaling from the base station.

In accordance with an exemplary embodiment, the information about the SL carrier may comprise one or more of:
buffer status for all services or for one or more services which are mapped to the SL carrier;
buffer status of current data;
buffer status of future data which is expected to come;
resource status of the SL carrier;
channel measurement information; and
a preference of power saving.

In accordance with an exemplary embodiment, the method according to the ninth aspect of the present disclosure may further comprise: receiving information about the SL carrier from a peer UE of the UE. In an embodiment, the information about the SL carrier may be used by the UE to determine whether to activate or deactivate the SL carrier.

In accordance with an exemplary embodiment, the UE may be configured with a timer for the SL carrier. In this case, the UE may perform various actions for the timer as described with respect to the first aspect of the present disclosure, e.g., start, restart or stop the timer according to different requirements.

In accordance with an exemplary embodiment, the activation or the deactivation of the SL carrier may be applicable for transmission on the SL carrier, or for reception on the SL carrier, or for both.

According to a tenth aspect of the present disclosure, there is provided an apparatus which may be implemented as a UE. The apparatus may comprise one or more processors and one or more memories storing computer program codes. The one or more memories and the computer program codes may be configured to, with the one or more processors, cause the apparatus at least to perform any step of the method according to the ninth aspect of the present disclosure.

According to an eleventh aspect of the present disclosure, there is provided a computer-readable medium having computer program codes embodied thereon which, when executed on a computer, cause the computer to perform any step of the method according to the ninth aspect of the present disclosure.

According to a twelfth aspect of the present disclosure, there is provided an apparatus which may be implemented as a UE. The apparatus may comprise a determining unit and a performing unit. In accordance with some exemplary embodiments, the determining unit may be operable to carry out at least the determining step of the method according to the ninth aspect of the present disclosure. The performing unit may be operable to carry out at least the performing step of the method according to the ninth aspect of the present disclosure.

According to a thirteenth aspect of the present disclosure, there is provided a method performed by a UE (e.g., a peer UE of the UE as described with respect to the first to fourth aspects and the ninth to twelfth aspects of the present disclosure). The method comprises: receiving, from a peer UE of the UE, an indication of activating or deactivating a SL carrier which is configured for the UE and the peer UE of the UE.

In accordance with an exemplary embodiment, the indication of activating or deactivating the SL carrier may comprise: an identifier of the SL carrier; and/or an indicator which indicates that the SL carrier needs to be activated or deactivated, etc.

In accordance with an exemplary embodiment, the indicator which indicates that the SL carrier needs to be activated or deactivated may be a bit associated with the SL carrier in a bitmap.

In accordance with an exemplary embodiment, the UE may be associated with a destination identifier which is associated with the SL carrier. In an embodiment, the destination identifier may be determined by the peer UE itself. In another embodiment, the destination identifier may be indicated to the peer UE by a base station.

In accordance with an exemplary embodiment, the method according to the thirteenth aspect of the present disclosure may further comprise: transmitting, to a base station, a notification of that the SL carrier is to be activated or deactivated.

In accordance with an exemplary embodiment, the method according to the thirteenth aspect of the present disclosure may further comprise: receiving, from the base station, an instruction of accepting or rejecting the activation or the deactivation of the SL carrier.

In accordance with an exemplary embodiment, the method according to the thirteenth aspect of the present disclosure may further comprise: determining whether to accept or reject the activation or the deactivation of the SL carrier, in response to the reception of the indication of activating or deactivating the SL carrier.

In accordance with an exemplary embodiment, the determination of whether to accept or reject the activation or the deactivation of the SL carrier may be made by the UE itself. In accordance with another exemplary embodiment, the determination of whether to accept or reject the activation or the deactivation of the SL carrier may be made by the UE according to an instruction to the UE, by a base station, of accepting or rejecting the activation or the deactivation of the SL carrier.

In accordance with an exemplary embodiment, the method according to the thirteenth aspect of the present disclosure may further comprise transmitting, to the peer UE of the UE, one or more of:
an acknowledgement indicating that the indication of activating or deactivating the SL carrier is received by the UE; and
a message indicating that the UE accepts or rejects the activation or the deactivation of the SL carrier.

In accordance with an exemplary embodiment, the activation or the deactivation of the SL carrier may be applicable for a direction from the peer UE of the UE to the UE.

In accordance with an exemplary embodiment, the method according to the thirteenth aspect of the present disclosure may further comprise: determining whether to activate or deactivate the SL carrier for a direction from the UE to the peer UE of the UE.

In accordance with an exemplary embodiment, the method according to the thirteenth aspect of the present disclosure may further comprise: receiving information about the SL carrier from the peer UE of the UE. In an embodiment, the information about the SL carrier may be used by the UE to determine whether to activate or deactivate the SL carrier.

In accordance with an exemplary embodiment, the information about the SL carrier may comprise one or more of:
buffer status for all services or for one or more services which are mapped to the SL carrier;
buffer status of current data;
buffer status of future data which is expected to come;
resource status of the SL carrier;
channel measurement information; and
a preference of power saving.

In accordance with an exemplary embodiment, the method according to the thirteenth aspect of the present disclosure may further comprise: transmitting information about the SL carrier to a base station and/or the peer UE of the UE. In an embodiment, the information about the SL carrier may be used by the base station and/or the peer UE of the UE to determine whether to activate or deactivate the SL carrier.

In accordance with an exemplary embodiment, the transmission of the information about the SL carrier may be performed by the UE periodically and/or event triggered. Alternatively or additionally, the transmission of the information about the SL carrier may be performed by the UE, upon reception of a request from the peer UE of the UE and/or upon reception of signaling from the base station.

In accordance with an exemplary embodiment, when the UE is configured with a timer for the SL carrier, the method according to the thirteenth aspect of the present disclosure may further comprise performing one or more of the following actions:
starting the timer upon the activation of the SL carrier;
restarting the timer in response to one or more events;
starting to deactivate the SL carrier when the timer is expired; and
stopping the timer when the UE starts to deactivate the SL carrier.

In accordance with an exemplary embodiment, the one or more events may comprise one or more of:
reception of DCI indicating one or more SL grants for the SL carrier by the UE;
transmission of a MAC PDU on the SL carrier by the UE in a configured SL grant;
transmission of SCI on the SL carrier after the UE obtains a SL grant; and
reception of SCI on the SL carrier by the UE indicating a coming reception from the peer UE of the UE.

In accordance with an exemplary embodiment, the activation or the deactivation of the SL carrier may be applicable for transmission on the SL carrier, or for reception on the SL carrier, or for both.

According to a fourteenth aspect of the present disclosure, there is provided an apparatus which may be implemented as a UE. The apparatus may comprise one or more processors and one or more memories storing computer program codes. The one or more memories and the computer program codes may be configured to, with the one or more processors, cause the apparatus at least to perform any step of the method according to the thirteenth aspect of the present disclosure.

According to a fifteenth aspect of the present disclosure, there is provided a computer-readable medium having computer program codes embodied thereon which, when executed on a computer, cause the computer to perform any step of the method according to the thirteenth aspect of the present disclosure.

According to a sixteenth aspect of the present disclosure, there is provided an apparatus which may be implemented as a UE. The apparatus may comprise a receiving unit and optionally a determining unit. In accordance with some exemplary embodiments, the receiving unit may be operable to carry out at least the receiving step of the method according to the thirteenth aspect of the present disclosure. The determining unit may be operable to carry out at least the determining step of the method according to the thirteenth aspect of the present disclosure.

According to a seventeenth aspect of the present disclosure, there is provided a method performed by a base station. The method comprises: receiving, from a UE, a notification of that a SL carrier configured for the UE and a peer UE of the UE is to be activated or deactivated. In accordance with an exemplary embodiment, the method further comprises: transmitting, to the UE, an instruction of accepting or rejecting activation or deactivation of the SL carrier.

In accordance with an exemplary embodiment, the UE may be associated with a destination identifier which is associated with the SL carrier. In an embodiment, the destination identifier may be determined by the peer UE of the UE and/or another base station serving the peer UE of the UE.

In accordance with an exemplary embodiment, the activation or the deactivation of the SL carrier may be applicable for a direction from the peer UE of the UE to the UE.

In accordance with an exemplary embodiment, the method according to the seventeenth aspect of the present disclosure may further comprise: receiving information about the SL carrier from the UE. In an embodiment, the information about the SL carrier may be used by the base station to determine whether to activate or deactivate the SL carrier.

In accordance with an exemplary embodiment, the information about the SL carrier may comprise: buffer status for all services or for one or more services which are mapped to the SL carrier; buffer status of current data; buffer status of future data which is expected to come; resource status of the SL carrier; channel measurement information; and/or a preference of power saving, etc.

In accordance with an exemplary embodiment, the activation or the deactivation of the SL carrier may be applicable for transmission on the SL carrier, or for reception on the SL carrier, or for both.

In accordance with an exemplary embodiment, the method according to the seventeenth aspect of the present disclosure may further comprise: exchanging information with one or more other base stations to determine whether to accept or reject the activation or the deactivation of the SL carrier.

According to an eighteenth aspect of the present disclosure, there is provided an apparatus which may be implemented as a base station. The apparatus may comprise one or more processors and one or more memories storing computer program codes. The one or more memories and the computer program codes may be configured to, with the one or more processors, cause the apparatus at least to perform any step of the method according to the seventeenth aspect of the present disclosure.

According to a nineteenth aspect of the present disclosure, there is provided a computer-readable medium having computer program codes embodied thereon which, when executed on a computer, cause the computer to perform any step of the method according to the seventeenth aspect of the present disclosure.

According to a twentieth aspect of the present disclosure, there is provided an apparatus which may be implemented as a base station. The apparatus may comprise a receiving unit and a transmitting unit. In accordance with some exemplary embodiments, the receiving unit may be operable to carry out at least the receiving step of the method according to the seventeenth aspect of the present disclosure. The transmitting unit may be operable to carry out at least the transmitting step of the method according to the seventeenth aspect of the present disclosure.

According to a twenty-first aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the method according to the fifth or seventeenth aspect of the present disclosure.

According to a twenty-second aspect of the present disclosure, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the method according to the fifth or seventeenth aspect of the present disclosure.

According to a twenty-third aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the method according to the first, ninth or thirteenth aspect of the present disclosure.

According to a twenty-fourth aspect of the present disclosure, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the method according to the first, ninth or thirteenth aspect of the present disclosure.

According to a twenty-fifth aspect of the present disclosure, there is provided a method implemented in a communication system which may include a host computer, a base station and a UE. The method may comprise, at the host computer, receiving user data transmitted to the base station from the UE which may perform any step of the method according to the first, ninth or thirteenth aspect of the present disclosure.

According to a twenty-sixth aspect of the present disclosure, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the method according to the first, ninth or thirteenth aspect of the present disclosure.

According to a twenty-seventh aspect of the present disclosure, there is provided a method implemented in a communication system which may include a host computer, a base station and a UE. The method may comprise, at the host computer, receiving, from the base station, user data originating from a transmission which the base station has received from the UE. The base station may perform any step of the method according to the fifth or seventeenth aspect of the present disclosure.

According to a twenty-eighth aspect of the present disclosure, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the method according to the fifth or seventeenth aspect of the present disclosure.

According to various exemplary embodiments, a SL carrier among all SL carriers configured to a UE may be activated or deactivated by the UE itself and/or according to signaling from a base station. This can make the activation/deactivation of a SL carrier feasible, regardless of whether the UE has a direct connection to the base station or is out of network coverage. In addition, the implementation of adaptive SL carrier activation/deactivation can save the power of the UE with satisfied quality of service (QOS).

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIGS. 1-5 are flowcharts illustrating various methods according to some embodiments of the present disclosure;

FIGS. 6A-6F are block diagrams illustrating various apparatuses according to some embodiments of the present disclosure;

FIG. 7 is a block diagram illustrating a telecommunication network connected via an intermediate network to a host computer in accordance with some embodiments of the present disclosure;

FIG. 8 is a block diagram illustrating a host computer communicating via a base station with a UE over a partially wireless connection in accordance with some embodiments of the present disclosure;

FIG. 9 is a flowchart illustrating a method implemented in a communication system, in accordance with an embodiment of the present disclosure;

FIG. 10 is a flowchart illustrating a method implemented in a communication system, in accordance with an embodiment of the present disclosure;

FIG. 11 is a flowchart illustrating a method implemented in a communication system, in accordance with an embodiment of the present disclosure; and

FIG. 12 is a flowchart illustrating a method implemented in a communication system, in accordance with an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “network node” refers to a network device in a communication network via which a terminal device accesses to the network and receives services therefrom. The network node may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

Wireless communication networks are widely deployed to provide various telecommunication services such as voice, video, data, messaging and broadcasts. To meet dramatically increasing network requirements on traffic capacity and data rates, one interesting option for communication technique development is to allow D2D communications to be implemented in a wireless communication network such as 4G/LTE or 5G/NR network. As used herein, D2D may be referred to in a broader sense to include communications between any types of UEs, and include V2X communications between a vehicle UE and any other type of UE. D2D and/or V2X may be a component of many existing wireless technologies when it comes to direct communication between wireless devices. D2D and/or V2X communications as an underlay to cellular networks may be proposed as an approach to take advantage of the proximity of devices.

NR SL communication is specified by 3GPP in Rel-16. The NR SL is an evolution of the LTE SL, in particular of the features introduced in Rel-14 and Rel-15 for V2X communication. Some of the most relevant features of the NR SL are the following:
Support for unicast and groupcast transmissions, in addition to broadcast transmissions, which were already supported in LTE.
Support for hybrid automatic repeat request (HARQ) feedback over the SL for unicast and groupcast. This feedback is conveyed by the receiver UE to the transmitter UE using the physical sidelink feedback channel (PSFCH). This functionality is new in NR compared to LTE.
To alleviate resource collisions among different sidelink transmissions launched by different UEs, it enhances channel sensing and resource selection procedures, which also lead to a new design of physical channels carrying the sidelink control information (SCI). The new design of the SCI simplifies coexistence between releases by grouping together all the information related to resource allocation (which is critical for coexistence) in a single channel with a robust, predefined format. Other control information is carried by other means, in a more flexible manner.
Grant-free transmissions, which are supported in NR uplink transmissions, are also provided in NR sidelink transmissions, to improve the latency performance.
To achieve a high connection density, congestion control and thus the QoS management is supported in NR sidelink transmissions.

In NR sidelink, the following physical layer (PHY) channels are defined:
PSCCH (Physical Sidelink Common Control Channel): This channel carries SCI including part of the scheduling assignment (SA) that allows a receiver to further process and decode the corresponding PSSCH (e.g., demodulation reference signal (DMRS) pattern and antenna port, modulation and coding scheme (MCS), etc.). In addition, the PSCCH indicates future reserved resources. This allows a receiver (RX) to sense and predict the utilization of the channel in the future. This sensing information is used for the purpose of UE-autonomous resource allocation (Mode 2), which is described below.
PSSCH (Physical Sidelink Shared Channel): The PSSCH is transmitted by a sidelink transmitter UE, which conveys sidelink transmission data (i.e., the SL shared channel SL-SCH), and a part of the SCI. In addition, higher layer control information may be carried using the PSSCH (e.g., medium access control (MAC) control elements (CEs), RRC signaling, etc.). For example, channel state information (CSI) is carried in the MAC CE over the PSSCH instead of the PSFCH.
PSFCH (Physical Sidelink feedback channel): The PSFCH is transmitted by a sidelink receiver UE for unicast and groupcast. It conveys the SL HARQ acknowledgement, which may consist of ACK/NACK (used for unicast and groupcast option 2) or NACK-only (used for groupcast option 1).
PSBCH (Physical Sidelink Broadcast Channel): The PSBCH conveys information related to synchronization, such as the direct frame number (DFN), indication of the slot and symbol level time resources for sidelink transmissions, in-coverage indicator, etc. The synchronization signal block (SSB) is transmitted periodically at every 160 ms. The PSBCH is transmitted along with the sidelink primary synchronization signal/sidelink secondary synchronization signal (S-PSS/S-SSS) as a sidelink synchronization signal block (S-SSB).
   Sidelink Primary/Secondary Synchronization Signal (S-PSS/S-SSS) are used by UEs to establish a common timing references among UEs in the absence of another reference such as global navigation satellite system (GNSS) time of network (NW) time.

Along with the different physical channels, reference signals (RS) are transmitted for different purposes, including demodulation RS (DM-RS), phase tracking RS (PT-RS), or RS for channel state information acquisition (CSI-RS).

Another new feature is the two-stage SCI. A first part (first stage) of the SCI is sent on the PSCCH. This part is used for channel sensing purposes (including the reserved time-frequency resources for transmissions, demodulation reference signal (DMRS) pattern and antenna port, etc.) and can be read by all UEs while the remaining part (second stage) of the SCI carries the remaining scheduling and control information such as a 8-bits source identity (ID) and a 16-bits destination ID, new data indicator (NDI), redundancy version (RV) and HARQ process ID is sent on the PSSCH to be decoded by the receiver UE.

In accordance with exemplary embodiments, NR sidelink can support the following two modes of resource allocation:
Mode 1: Sidelink resources are scheduled by a gNB.
Mode 2: The UE autonomously selects sidelink resources from a (pre-) configured sidelink resource pool. To avoid collisions between UEs, a procedure based on the channel sensing and resource reservation is used.

An in-coverage UE can be configured by a gNB to use Mode 1 or Mode 2. For the out-of-coverage UE, only Mode 2 can be used.

Like in LTE, scheduling over the sidelink in NR is done in different ways for Mode 1 and Mode 2. In Mode 1, the grant is provided by the gNB. The following two kinds of grants are supported:
Dynamic grants are provided for one or multiple transmissions of a single packet (i.e., transport block). When the traffic to be sent over sidelink arrives at a transmitter UE (i.e., at the corresponding TX buffer), the UE initiates the four-message exchange procedure to request sidelink resources from a gNB (scheduling request (SR) on UL, grant, buffer status report (BSR) on UL, grant for data on SL sent to UE). A gNB indicates the resource allocation for the PSCCH and the PSSCH in the downlink control information (DCI) conveyed by physical downlink control channel (PDCCH) with cyclic redundancy check (CRC) scrambled with the sidelink radio network temporary identity (SL-RNTI) of the corresponding UE. A UE receiving such a DCI, assumes that it has been provided a SL dynamic grant only if the detects that the CRC of DCI has been scrambled with its SL-RNTI. A transmitter UE then indicates the time-frequency resources and the transmission scheme of the allocated PSSCH in the PSCCH, and launches the PSCCH and the PSSCH on the allocated resources for sidelink transmissions. When a grant is obtained from a gNB, a transmitter UE can only transmit a single transport block (TB). As a result, this kind of grant is suitable for traffic with a loose latency requirement.
Configured grant: For the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, this UE can launch the PSCCH and the PSSCH on the upcoming resource occasion. This kind of grant is also known as grant-free transmissions.

It is noted that only the transmitter UE is scheduled by the gNB. The receiver UE does not receive any information directly from the gNB. Instead, it is scheduled by the transmitter UE by means of the SCI. Therefore, a receiver UE may need to perform blind decoding to identify the presence of PSCCH and find the resources for the PSSCH through the SCI.

In Mode 2 resource allocation, the grant is generated by the UE itself. When traffic arrives at a transmitter UE (i.e., at the corresponding TX buffer), this transmitter autonomously selects resources for the PSCCH and the PSSCH. To further enhance the probability of successful TB decoding at one shot and thus suppress the probability to perform retransmissions, a transmitter UE may repeat the TB transmission along with the initial TB transmission. These retransmissions may be triggered by the corresponding SL HARQ feedback or may be sent blindly by the transmitter UE. In either case, to minimize the probability of collision for potential retransmissions, the transmitter UE may also reserve the corresponding resources for PSCCH/PSSCH for retransmissions. That is, the transmitter UE selects resources for:
1) The PSCCH/PSSCH corresponding to the first transmission.
2) The PSCCH/PSCCH corresponding to the retransmissions. Resources for up to 2 retransmissions may be reserved. These reserved resources may be always used in case of blind retransmissions. If SL HARQ feedback is used, the used of the reserved resources may be conditional on a negative SL HARQ acknowledgement.

Since each transmitter UE in sidelink transmissions may need to autonomously select resources for its own transmissions, preventing the different transmitter UEs from selecting the same resources turns out to be a critical issue in Mode 2. A particular resource selection procedure is therefore imposed to Mode 2 based on channel sensing. The channel sensing algorithm involves detecting the reservations transmitted by other UEs and performing power measurements (i.e., reference signal received power or RSRP) on the incoming transmissions.

As specified in clause 5.9 of 3GPP technical specification (TS) 38.321 V16.6.0, if the MAC entity is configured with one or more SCells, the network may activate and deactivate the configured SCells. Upon configuration of an SCell, the SCell is deactivated unless the parameter sCellState is set to activated for the SCell by upper layers.

In accordance with exemplary embodiments, the configured SCell(s) may be activated and deactivated by:
receiving the SCell Activation/Deactivation MAC CE, e.g., as described in clause 6.1.3.10 of 3GPP TS 38.321 V16.6.0;
configuring sCellDeactivationTimer timer per configured SCell (except the SCell configured with physical uplink control channel (PUCCH), if any): the associated SCell is deactivated upon its expiry;
configuring sCellState per configured SCell: if configured, the associated SCell is activated upon SCell configuration.

In accordance with exemplary embodiments, for each configured SCell, the MAC entity may perform the following operations:
1> if an SCell is configured with sCellState set to activated upon SCell configuration, or an SCell Activation/Deactivation MAC CE is received activating the SCell:
   2> if the SCell was deactivated prior to receiving this SCell Activation/Deactivation MAC CE; or
   2> if the SCell is configured with sCellState set to activated upon SCell configuration:
      3> if firstActiveDownlinkBWP-Id is not set to dormant bandwidth part (BWP):
         4> activate the SCell according to the timing for MAC CE activation and according to the timing for direct SCell activation; i.e. apply normal SCell operation including:
         5> sounding reference signal (SRS) transmissions on the SCell;
         5> CSI reporting for the SCell;
         5> PDCCH monitoring on the SCell;
         5> PDCCH monitoring for the SCell;
      5> PUCCH transmissions on the SCell, if configured.
         3> else (i.e. firstActiveDownlinkBWP-Id is set to dormant BWP):
      4> stop the bwp-InactivityTimer of this Serving Cell, if running.
      3> activate the downlink (DL) BWP and uplink (UL) BWP indicated by firstActiveDownlinkBWP-Id and firstActiveUplinkBWP-Id respectively.
   2> start or restart the sCellDeactivationTimer associated with the SCell according to the timing for MAC CE activation and according to the timing for direct SCell activation;
   2> if the active DL BWP is not the dormant BWP:
      3> (re-) initialize any suspended configured uplink grants of configured grant Type 1 associated with this SCell according to the stored configuration, if any, and to start in the symbol according to rules in clause 5.8.2 of 3GPP TS 38.321 V16.6.0;
      3> trigger power headroom (PHR) according to clause 5.4.6 of 3GPP TS 38.321 V16.6.0.
1> else if an SCell Activation/Deactivation MAC CE is received deactivating the SCell; or
1> if the sCellDeactivationTimer associated with the activated SCell expires:
   2> deactivate the SCell according to the timing;
   2> stop the sCellDeactivationTimer associated with the SCell;
   2> stop the bwp-InactivityTimer associated with the SCell;
   2> deactivate any active BWP associated with the SCell;
   2> clear any configured downlink assignment and any configured uplink grant Type 2 associated with the SCell respectively;
   2> clear any physical uplink shared channel (PUSCH) resource for semi-persistent CSI reporting associated with the SCell;
   2> suspend any configured uplink grant Type 1 associated with the SCell;
   2> flush all HARQ buffers associated with the SCell;
   2> cancel, if any, triggered consistent listen-before-talk (LBT) failure for the SCell.
1> if PDCCH on the activated SCell indicates an uplink grant or downlink assignment; or
1> if PDCCH on the Serving Cell scheduling the activated SCell indicates an uplink grant or a downlink assignment for the activated SCell; or
1> if a MAC PDU is transmitted in a configured uplink grant and LBT failure indication is not received from lower layers; or
1> if a MAC PDU is received in a configured downlink assignment:
   2> restart the sCellDeactivationTimer associated with the SCell.
1> if the SCell is deactivated:
   2> not transmit SRS on the SCell;
   2> not report CSI for the SCell;
   2> not transmit on UL-SCH on the SCell;
   2> not transmit on random access channel (RACH) on the SCell;
   2> not monitor the PDCCH on the SCell;
   2> not monitor the PDCCH for the SCell;
   2> not transmit PUCCH on the SCell.

In accordance with an exemplary embodiment, HARQ feedback for the MAC PDU containing SCell Activation/Deactivation MAC CE may not be impacted by PCell, primary secondary cell (PSCell) and PUCCH SCell interruptions due to SCell activation/deactivation.

In 3GPP, CA is being proposed for Rel-18 SL topics, and it is most likely to be agreed by 3GPP as one Rel-18 topic. For CA in Uu, an SCell can be activated or deactivated via different signaling alternatives. This may be used to activate or deactivate data transmission in the SCell for a UE while the UE is in CA. For the similar reason, it may be needed to also introduce an activation/deactivation mechanism for a SL UE in CA. In Uu, a gNB may send signaling to activate or deactivate an SCell for a UE using RRC signaling or MAC CE. Such signaling alternatives may not be directly reused for a SL UE in CA, for example due to the following reasons:
A SL radio bearer (RB) is directional, which is different from that of a Uu RB. In this case, for a UE pair, e.g., UE1 and UE2, for a service, the UE pair may need to set up 2 SL RBs, e.g., SL RB1 and SL RB2, where SL RB1 is for the transmission direction from UE1 to UE2, and SL RB2 is for the transmission direction from UE2 to UE1. Due to this, UE1 and UE2 are equally positioned. UE1 or UE2 is typically only able to control one direction, however, without controlling the reverse direction.
For a SL UE pair out of network coverage, a gNB may not be able to control the link of the SL UE pair.

Therefore, it may be desirable to design a mechanism of activation and deactivation for a SL carrier in case of SL CA.

Various exemplary embodiments of the present disclosure propose solutions to enable a gNB or a SL UE to activate or deactivate a SL carrier in case of CA. In accordance with an exemplary embodiment, for a UE configured with SL CA, if the UE connects to a gNB, the gNB may determine when to activate or deactivate a SL carrier. In accordance with another exemplary embodiment, for one or multiple UEs out of network coverage and configured with SL CA, at least one UE among these UEs may determine when to activate or deactivate a SL carrier. In an embodiment, SL UEs may exchange status information of a SL carrier, based on which the UEs may determine when to activate or deactivate a SL carrier. In another embodiment, a timer may be defined for each SL carrier for a UE in case of CA. The UE may operate the timer, e.g., start, restart or stop the timer, according to different requirements. The operation(s) of the timer may be associated with activation and deactivation of the corresponding SL carrier.

Many advantages may be achieved by applying the proposed solutions. For example, it may be feasible for a SL UE to activate or deactivate a SL carrier among all configured SL carriers. In addition, the SL UE may be able to achieve a good balance between power saving and QoS satisfaction of services.

It can be appreciated that although some exemplary embodiments are described in the context of NR random access technology (RAT), various embodiments described in the present disclosure may be in general applicable to any kind of communication scenarios involving D2D communications. For example, various embodiments described in the present disclosure may also be applicable to LTE RAT and any other RAT enabling direct communication between two (or more) nearby devices without any loss of meaning.

Various embodiments described in the present disclosure may be applicable to activating and/or deactivating a SL carrier in case of CA for one or multiple SL UEs with SL transmission cast types including unicast, groupcast and broadcast. It can be appreciated that the connection between UEs may not be limited to sidelink. Any short-range communication technology such as wireless fidelity (WiFi) may also be equally applicable.

A SL UE configured with SL CA, means that the UE may be configured with multiple SL carriers for its SL transmissions or receptions. So the UE can aggregate these SL carriers together for its SL transmissions or receptions. The UE may be able to perform transmissions or receptions according to at least one of the following modes:
The UE may only use one of the SL carriers to perform SL transmission or reception.
The UE may use multiple SL carriers of the configured SL carriers simultaneously to perform SL transmission or reception. A transmission or reception on a SL carrier may be fully or partially overlapping in time domain with another transmission or reception on another SL carrier.

In accordance with an exemplary embodiment, for one or multiple SL UEs configured with SL CA, in case at least one of the UEs has network coverage, e.g., has a direct connection to a gNB, the gNB may send signaling to the UE to activate or deactivate a specific SL carrier. In an embodiment, the gNB may send the signaling to the UE via at least one of the following signaling alternatives:
system information;
dedicated RRC signaling;
a MAC CE; and
physical layer (L1) signaling such as DCI.

In accordance with an exemplary embodiment, the signaling sent from the gNB to the UE may carry at least one of the following information:
identifiers (e.g., indexes, etc.) of one or multiple SL carriers which may need to be activated or deactivated;
indicators of one or multiple SL carriers, where each indicator may indicate whether the associated SL carrier needs to be activated or deactivated;
one or multiple destination IDs associated to the SL carriers; and
one or more conditions under which SL carrier(s) may need to be activated or deactivated, for example, the one or more conditions may include:
   a threshold indicating a shortest time period during which there may not be any SL transmission or reception on a carrier so that this carrier can be deactivated, and in an embodiment, there may be one separate threshold per SL carrier; and/or
   a buffer threshold above which the UE may need to activate a SL carrier in order to cope with higher data volume.

In accordance with an exemplary embodiment, a bitmap field containing multiple bits may be defined in the signaling sent from the gNB to the UE. Each bit may represent a specific SL carrier. According to an embodiment, the bit with the value ‘1’ may indicate that the associated SL carrier needs to be activated, while the bit with the value ‘0’ may indicate that the associated SL carrier needs to be deactivated.

In accordance with an exemplary embodiment, different information contents sent from the gNB to the UE may be carried by different signaling alternatives. In this case, some of the information (e.g., the bitmap, etc.) may be carried in one type of signaling (e.g., a MAC CE or DCI, etc.), while some other of the information (e.g., the one or more conditions, etc.) may be carried in another type of signaling (e.g., system information or dedicated RRC signaling, etc.).

In accordance with an exemplary embodiment, upon reception of the signaling from the gNB, the UE may perform at least one of the following operations:
Operation 1: if the signaling indicates that the SL carrier is being activated, the UE may activate the SL carrier as below:
   activate the SL carrier according to a timing which may be determined according to the received signaling; and
   apply one or more normal SL carrier operations, e.g., including at least one of the following operations:
      CSI request for the SL carrier;
      CSI reporting for the SL carrier;
      SCI monitoring on the SL carrier;
      sensing on the SL carrier if the UE adopts mode 2 resource allocation;
      PSSCH reception;
      PSFCH monitoring on the SL carrier;
      PSSCH transmission on the SL carrier if triggered;
      PSCCH transmission on the SL carrier if triggered; and
      PSFCH transmission on the SL carrier if triggered.
Operation 2: if the signaling indicates that the SL carrier is being deactivated, the UE may deactivate the SL carrier as below:
   deactivate the SL carrier according to the timing which may be determined by the UE according to the received signaling;
   deactivate any active BWP associated with the SL carrier;
   clear any configured SL grant Type 2 associated with the SL carrier;
   suspend any configured SL grant Type 1 associated with the SL carrier;
   clear any mode 2 SL grant associated with the SL carrier;
   stop sensing on the SL carrier if the UE adopts mode 2 resource allocation;
   flush all HARQ buffers associated with the SL carrier; and
   stop SL transmission/reception on the SL carrier.
Operation 3: if the signaling indicates which condition(s) SL carrier(s) may need to be activated or deactivated, the UE can determine whether a SL carrier needs to be activated or deactivated based on the condition(s) and then perform the operation(s) as described in Operation 1 or Operation 2 above accordingly.

In accordance with an exemplary embodiment, for one or multiple SL UEs configured with SL CA, in case at least one of the UE has network coverage, i.e., has a direct connection to a gNB, the gNB may send signaling to the UE to activate or deactivate a specific SL carrier. Upon reception of the signaling, the UE may further send signaling to one or more other SL UEs configured with the same SL carrier, informing them of activation or deactivation of the SL carrier via at least one of the following signaling alternatives:
PC5-S signaling;
PC5-RRC signaling;
a MAC CE; and
L1 signaling on physical channels such as PSSCH, PSCCH, PSFCH, etc.

In accordance with an exemplary embodiment, the signaling sent from the UE to the one or more other SL UEs may carry at least one of the following information:
identifiers (e.g., indexes, etc.) of one or multiple SL carriers which may need to be activated or deactivated; and
indicators of one or multiple SL carriers, where each indicator may indicate whether the associated SL carrier needs to be activated or deactivated.

In accordance with an exemplary embodiment, a bitmap field containing multiple bits may be defined in the signaling sent from the UE to the one or more other SL UEs. Each bit may represent a specific SL carrier. According to an embodiment, the bit with the value ‘1’ may indicate that the associated SL carrier needs to be activated, while the bit with the value ‘0’ may indicate that the associated SL carrier needs to be deactivated.

In accordance with an exemplary embodiment, the UE may send the signaling to the one or more other SL UEs in a SL carrier that is currently activated. According to an embodiment, the UE may only send the signaling to the associated destinations which may be indicated in the signaling received from the gNB.

In accordance with an exemplary embodiment, upon reception of the signaling from the gNB indicating activation or deactivation of a SL carrier, the UE may first send signaling to one or more other SL UEs configured with the same SL carrier, informing them of activation or deactivation of the SL carrier. After that, when the UE has received an acknowledgement from at least one UE of the one or more other SL UEs indicating that the at least one UE has received the signaling indicating activation or deactivation of the SL carrier, the UE may perform one or more operations as described in Operation 1 or Operation 2 to activate or deactivate the SL carrier. Alternatively or additionally, the UE may perform one or more operations to activate or deactivate the SL carrier, when the UE has received a response message from at least one UE of the one or more other SL UEs indicating acceptance to the activation or deactivation of the SL carrier.

In accordance with an exemplary embodiment, upon reception of the signaling from the gNB indicating activation or deactivation of a SL carrier, without sending further signaling to one or more other SL UEs configured with the same SL carrier informing them of activation or deactivation of the SL carrier, the UE may perform one or more operations as described in Operation 1 or Operation 2 to activate or deactivate the SL carrier.

In accordance with an exemplary embodiment, when the UE is out of network coverage, the UE may decide to activate or deactivate a SL carrier by itself. In this case, the UE may generate signaling by itself and send the signaling to one or more other SL UEs (e.g., peer UEs) configured with the same SL carrier, informing them of activation or deactivation of the SL carrier. In an embodiment, at least one peer UE may provide a response message to the UE, indicating acceptance or rejection to the UE's decision of activating or deactivating the SL carrier. In this case, the UE may then perform further operation(s) to activate or deactivate the SL carrier only when the UE has received the response message from the at least one peer UE indicating acceptance to the UE's decision of activating or deactivating the SL carrier. Alternatively or additionally, the UE may perform one or more operations to activate or deactivate the SL carrier, when the UE receives an acknowledgement from at least one peer UE indicating that the at least one peer UE has received the signaling indicating activation or deactivation of the SL carrier.

In accordance with an exemplary embodiment, for one or multiple SL UEs configured with SL CA, in case at least one of the UE has network coverage, i.e., has a direct connection to a gNB, the gNB may send signaling to the UE to activate or deactivate a specific SL carrier. Upon reception of the signaling, the UE may further send signaling to one or more other SL UEs configured with the same SL carrier, informing them of activation or deactivation of the SL carrier. Upon reception of the signaling, the one or more other UEs may perform operations as described in Operation 1 or Operation 2 to activate or deactivate the SL carrier. For example, when receiving the signaling indicating activation or deactivation of a SL carrier from the UE, a peer UE of the UE may also perform one or more operations as described in Operation 1 or Operation 2 to activate or deactivate the same SL carrier. In this case, the UE may only activate or deactivate the SL carrier for the direction from the UE to the peer UE, while the peer UE may activate or deactivate the SL carrier for the direction from the peer UE to the UE. In other words, a UE may be able to activate or deactivate a SL carrier for a specific direction.

In accordance with an exemplary embodiment, for a UE configured with SL CA, if a UE has received signaling from one of its peer UEs for activation or deactivation of a specific SL carrier, the UE may forward the signaling to a gNB if the UE has a connection to the gNB. The gNB may provide further signaling to the UE indicating acceptance or rejection for the activation or deactivation of the SL carrier. After reception of the signaling from the gNB, the UE may further forward the signaling to its peer UE(s).

In accordance with an exemplary embodiment, a UE configured with SL CA may provide its peer UE with information on a SL carrier including at least one of the following information:
buffer status, e.g., including buffer size and/or priority indication of services;
   in an option, the UE may report buffer status for all services;
   in another option, the UE may report buffer status of services which are mapped to the concerned SL carrier;
   buffer status may contain status of current data and/or status of future data which is expected to come.
resource status of the SL carrier, e.g., including one or more of:
   the fraction of the resources which are occupied/consumed by the UE;
   the fraction of the available resource.
radio channel quality measured by the UE in terms of metrics such as RSRP, reference signal received quality (RSRQ), received signal strength indicator (RSSI), signal to interference plus noise ratio (SINR), signal to interference ratio (SIR), etc.;
measurements by the UE in terms of other metrics such as channel occupancy, channel busy ratio (CBR), or channel usage ratio (CR), etc.;
other information such as the preference of power saving.

In accordance with an exemplary embodiment, upon reception of the information about the SL carrier from the UE, the UE's peer UE may consider the information to decide whether to activate or deactivate the SL carrier. The UE's peer UE may also reply to the UE with the decision.

In accordance with an exemplary embodiment, the UE may provide the information about the SL carrier to one or multiple its peer UEs via at least one of the following fashions:
periodically;
event triggered;
upon reception of a request message from a peer UE; and
upon reception of signaling from the gNB.

In accordance with an exemplary embodiment, the UE and/or its peer UE may also report/forward the information about the SL carrier to their gNBs respectively, so that the gNBs may consider the information to decide whether to activate or deactivate the SL carrier.

In accordance with an exemplary embodiment, for a UE configured with SL CA, a timer may be defined for each SL carrier for monitoring activities of the UE on the SL carrier. In an embodiment, for each configured SL carrier, the UE may start the timer upon activation of the SL carrier, and/or the timer may be restarted when any one of the following conditions fulfill:
the UE has received DCI signaling on PDCCH in a serving cell indicating one or multiple SL grants for the SL carrier;
a MAC PDU is transmitted on the SL carrier by the UE in a configured SL grant;
SCI is transmitted on the SL carrier after the UE has obtained a SL grant using Mode 2 resource allocation; and
SCI is received from the SL carrier by the UE indicating a coming reception from another UE.

In accordance with another exemplary embodiment, the timer may be restarted when any one of the following conditions fulfill:
SCI is transmitted on the SL carrier after the UE has obtained a SL grant using either Mode 1 or Mode 2 resource allocation; and
SCI is received from the SL carrier by the UE indicating a coming reception from another UE.

In accordance with an exemplary embodiment, when the timer defined for the SL carrier is expired, the UE may start to deactivate the SL carrier. Alternatively or additionally, the timer defined for the SL carrier may be stopped when the UE starts to deactivate the SL carrier.

In accordance with an exemplary embodiment, SL carrier activation/deactivation may be performed for transmission and reception by a UE separately. That means, a SL carrier may be only activated by the UE for transmission, or for reception, or for both. In this case, the signaling/parameter/procedure as described above for activating or deactivating a SL carrier may be defined/performed separately for transmission and reception of the SL carrier respectively.

In accordance with an exemplary embodiment, for SL UEs configured with the same set of SL carriers in case of SL CA, if there is only one gNB involved in the procedure to determine whether to activate or deactivate a SL carrier, that gNB may decide when to activate or deactivate the SL carrier. If there may be multiple gNBs involved in the procedure to determine whether to activate or deactivate a SL carrier, theses gNBs may need to exchange information or signaling via inter-gNB interface. During the procedure, there may be one gNB which is selected to take the final decision for activation or deactivation of the SL carrier. Alternatively or additionally, a gNB serving a UE may only decide whether to activate or deactivate a SL carrier for SL transmission, while a gNB serving the UE's peer UE may either accept or reject the decision for activation or deactivation of the SL carrier. In the case that the decision is accepted, the peer UE may have the relevant SL carrier activated at least for SL reception. If there is no any gNB involved in the procedure to determine whether to activate or deactivate a SL carrier, i.e., all UEs are out of network coverage, there may be one UE which is selected to take the final decision on when to active or deactivate the SL carrier.

It is noted that some embodiments of the present disclosure are mainly described in relation to 4G/LTE or 5G/NR specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies may equally be utilized as long as exemplary embodiments described herein are applicable.

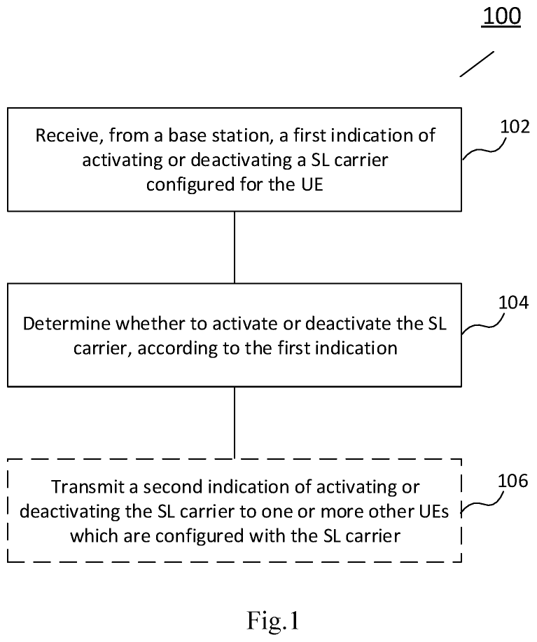

FIG. 1 is a flowchart illustrating a method 100 according to some embodiments of the present disclosure. The method 100 illustrated in FIG. 1 may be performed by a UE or an apparatus communicatively coupled to the UE. In accordance with an exemplary embodiment, the UE may be configured to support D2D communication (e.g., V2X or SL communication, etc.) with other devices. In an exemplary embodiment, the UE may be configured to communicate with a network node (e.g., a base station such as gNB, etc.) directly or via a relay UE.

According to the exemplary method 100 illustrated in FIG. 1, the UE may receive, from a base station, a first indication of activating or deactivating a SL carrier configured for the UE, as shown in block 102. According to the first indication, the UE may determine whether to activate or deactivate the SL carrier, as shown in block 104.

In accordance with an exemplary embodiment, the first indication may comprise one or more of the following information:
an identifier of the SL carrier;
an indicator which indicates that the SL carrier needs to be activated or deactivated;
one or more destination identifiers associated with the SL carrier; and
one or more factors, where when the one or more factors are satisfied, the SL carrier may need to be activated or deactivated.

In accordance with an exemplary embodiment, the one or more factors may comprise one or more of:
a time threshold indicating a time period during which the SL carrier may need to be deactivated;
a buffer threshold above which the SL carrier may need to be activated;
timing of activating the SL carrier; and
timing of deactivating the SL carrier.

In accordance with an exemplary embodiment, the indicator which indicates that the SL carrier needs to be activated or deactivated may be a bit associated with the SL carrier in a bitmap.

In accordance with an exemplary embodiment, the UE may determine whether to activate or deactivate the SL carrier, based at least in part on the one or more factors.

In accordance with an exemplary embodiment, when the UE determines to activate the SL carrier, the UE may activate the SL carrier according to the first indication. In accordance with another exemplary embodiment, when the UE determines to deactivate the SL carrier, the UE may deactivate the SL carrier according to the first indication.

In accordance with an exemplary embodiment, the deactivation of the SL carrier may comprise one or more of:
clearing any mode 2 SL grant associated with the SL carrier;
stopping sensing on the SL carrier if the UE adopts mode 2 resource allocation;
stopping SL transmission on the SL carrier; and
stopping SL reception on the SL carrier.

It can be appreciated that the deactivation of the SL carrier may also comprise any other suitable operation for deactivating the SL carrier, e.g., deactivating any active BWP associated with the SL carrier, clearing any configured SL grant Type 2 associated with the SL carrier, suspending any configured SL grant Type 1 associated with the SL carrier, flushing all HARQ buffers associated with the SL carrier, etc.

In accordance with an exemplary embodiment, the SL carrier may be activated or deactivated according to timing information which may be determined based at least in part on the first indication.

In accordance with an exemplary embodiment, the UE may transmit a second indication of activating or deactivating the SL carrier to one or more other UEs which are configured with the SL carrier, as shown in block 106. In an embodiment, the second indication may comprise: an identifier of the SL carrier, and/or an indicator which indicates that the SL carrier needs to be activated or deactivated, etc.

In accordance with an exemplary embodiment, the one or more other UEs may be associated with one or more destination identifiers which are associated with the SL carrier and indicated by the first indication.

In accordance with an exemplary embodiment, the UE may receive, from at least one of the one or more other UEs, an acknowledgement indicating that the second indication is received by the at least one of the one or more other UEs. Alternatively or additionally, the UE may receive, from at least one of the one or more other UEs, a message indicating that the at least one of the one or more other UEs accepts or rejects the activation or the deactivation of the SL carrier.

In accordance with an exemplary embodiment, the activation or the deactivation of the SL carrier may be performed by the UE when receiving, from at least one of the one or more other UEs, an acknowledgement indicating that the second indication is received by the at least one of the one or more other UEs. Alternatively or additionally, the activation or the deactivation of the SL carrier may be performed by the UE when receiving, from at least one of the one or more other UEs, a message indicating that the at least one of the one or more other UEs accepts the activation or the deactivation of the SL carrier.

In accordance with an exemplary embodiment, the activation or the deactivation of the SL carrier as described with respect to FIG. 1 may be applicable for a direction from the UE to a peer UE of the UE.

In accordance with an exemplary embodiment, the UE may transmit information about the SL carrier to the base station and/or a peer UE of the UE. In an embodiment, the information about the SL carrier may be used by the base station and/or the peer UE of the UE to determine whether to activate or deactivate the SL carrier.

In accordance with an exemplary embodiment, the transmission of the information about the SL carrier may be performed by the UE in one or more of the following ways:
periodically;
event triggered;
upon reception of a request from the peer UE of the UE; and
upon reception of signaling from the base station.

In accordance with an exemplary embodiment, the information about the SL carrier may comprise one or more of:
buffer status for all services or for one or more services which are mapped to the SL carrier;
buffer status of current data;
buffer status of future data which is expected to come;
resource status of the SL carrier;
channel measurement information; and
a preference of power saving.

In accordance with an exemplary embodiment, the UE may receive information about the SL carrier from a peer UE of the UE. In an embodiment, the information about the SL carrier may be used by the UE to determine whether to activate or deactivate the SL carrier.

In accordance with an exemplary embodiment, when the UE is configured with a timer for the SL carrier, the UE may perform one or more of the following actions:
starting the timer upon the activation of the SL carrier;
restarting the timer in response to one or more events;
starting to deactivate the SL carrier when the timer is expired; and
stopping the timer when the UE starts to deactivate the SL carrier.

In accordance with an exemplary embodiment, the one or more events may comprise one or more of:
reception of DCI indicating one or more SL grants for the SL carrier by the UE;
transmission of a MAC PDU, on the SL carrier by the UE in a configured SL grant;
transmission of SCI on the SL carrier after the UE obtains a SL grant; and
reception of SCI on the SL carrier by the UE indicating a coming reception from a peer UE of the UE.

In accordance with an exemplary embodiment, the activation or the deactivation of the SL carrier as described with respect to FIG. 1 may be applicable for transmission on the SL carrier, or for reception on the SL carrier, or for both.

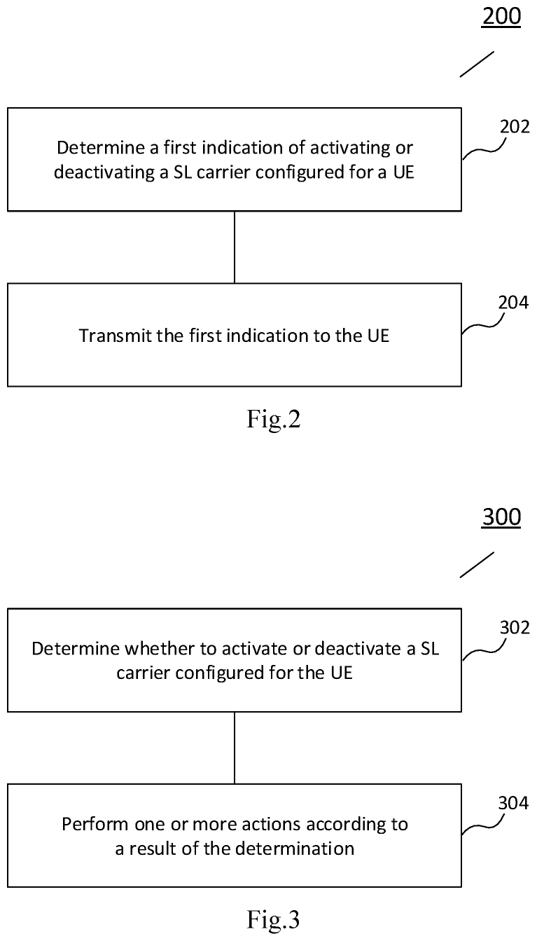

FIG. 2 is a flowchart illustrating a method 200 according to some embodiments of the present disclosure. The method 200 illustrated in FIG. 2 may be performed by a base station (e.g., a gNB, an AP, etc.) or an apparatus communicatively coupled to the base station. In accordance with an exemplary embodiment, the base station may be configured to support cellular coverage extension with D2D communication (e.g., V2X or SL communication, etc.). In an exemplary embodiment, the base station may be configured to communicate with a terminal device such as a UE, e.g. directly or via a relay UE.

According to the exemplary method 200 illustrated in FIG. 2, the base station may determine a first indication of activating or deactivating a SL carrier configured for a UE (e.g., the UE as described with respect to FIG. 1), as shown in block 202. In accordance with an exemplary embodiment, the base station may transmit the first indication to the UE, as shown in block 204. In an embodiment, the UE may be able to transmit a second indication (e.g., the second indication as described with respect to FIG. 1) of activating or deactivating the SL carrier to one or more other UEs which are configured with the SL carrier.

In accordance with an exemplary embodiment, the first indication transmitted by the base station according to the method 200 may correspond to the first indication received by the UE according to the method 100. Thus, the first indication as described with respect to FIG. 1 and FIG. 2 may have the same or similar contents and/or feature elements.

In accordance with an exemplary embodiment, the base station may receive, from a peer UE of the UE, a notification of that the SL carrier is to be activated or deactivated. In an embodiment, the base station may transmit, to the peer UE of the UE, an instruction of accepting or rejecting the activation or the deactivation of the SL carrier.

In accordance with an exemplary embodiment, the peer UE of the UE may be associated with a destination identifier which is associated with the SL carrier and indicated by the first indication.

In accordance with an exemplary embodiment, the base station may receive information about the SL carrier from the UE. In an embodiment, the information about the SL carrier may be used by the base station to determine whether to activate or deactivate the SL carrier.

In accordance with an exemplary embodiment, the information about the SL carrier received by the base station according to the method 200 may correspond to the information about the SL carrier transmitted by the UE according to the method 100. Thus, the information about the SL carrier as described with respect to FIG. 1 and FIG. 2 may have the same or similar contents and/or feature elements.

In accordance with an exemplary embodiment, the base station may exchange information with one or more other base stations to determine whether to activate or deactivate the SL carrier.

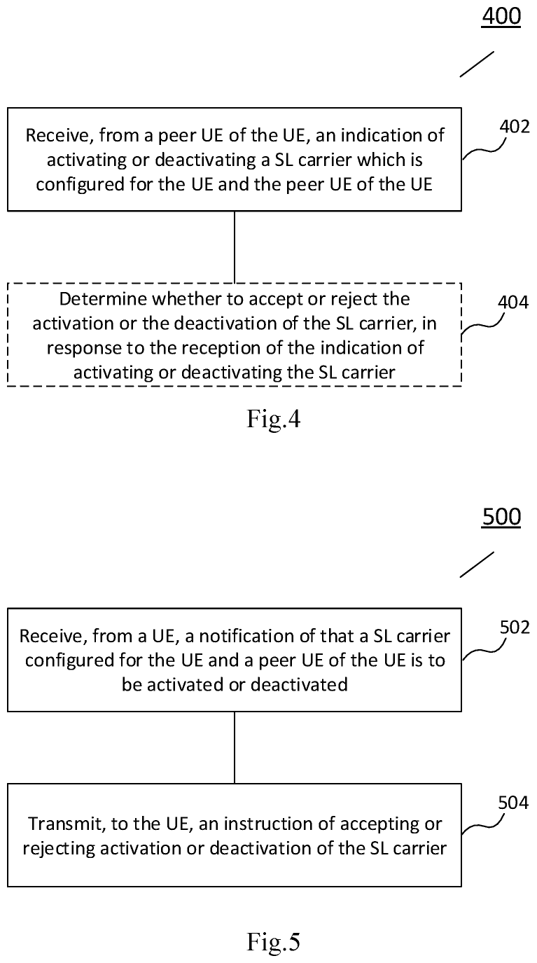

FIG. 3 is a flowchart illustrating a method 300 according to some embodiments of the present disclosure. The method 300 illustrated in FIG. 3 may be performed by a UE or an apparatus communicatively coupled to the UE. In accordance with an exemplary embodiment, the UE may be configured to support D2D communication (e.g., V2X or SL communication, etc.) with other devices. In an exemplary embodiment, the UE may be configured to communicate with a network node (e.g., a base station such as gNB, etc.) directly or via a relay UE.

According to the exemplary method 300 illustrated in FIG. 3, the UE may determine whether to activate or deactivate a SL carrier configured for the UE, as shown in block 302. In accordance with an exemplary embodiment, the UE may perform one or more actions according to a result of the determination, as shown in block 304.

In accordance with an exemplary embodiment, the determination of whether to activate or deactivate the SL carrier may be made by the UE itself, without receiving a first indication (e.g., the first indication as described with respect to FIG. 1 and FIG. 2) of activating or deactivating the SL carrier from a base station.

In accordance with an exemplary embodiment, the one or more actions performed by the UE may comprise: activating or deactivating the SL carrier, according to timing information determined by the UE.

In accordance with an exemplary embodiment, the deactivation of the SL carrier may comprise: clearing any mode 2 SL grant associated with the SL carrier; stopping sensing on the SL carrier if the UE adopts mode 2 resource allocation; stopping SL transmission on the SL carrier; and/or stopping SL reception on the SL carrier, etc.

In accordance with an exemplary embodiment, the one or more actions performed by the UE may comprise: generating a second indication of activating or deactivating the SL carrier. In accordance with another exemplary embodiment, the one or more actions performed by the UE may further comprise: transmitting the second indication to one or more other UEs which are configured with the SL carrier.

In accordance with an exemplary embodiment, the second indication may comprise: an identifier of the SL carrier; and/or an indicator which indicates that the SL carrier needs to be activated or deactivated, etc. In an embodiment, the indicator which indicates that the SL carrier needs to be activated or deactivated may be a bit associated with the SL carrier in a bitmap.

In accordance with an exemplary embodiment, the one or more other UEs may be associated with one or more destination identifiers which are associated with the SL carrier and determined by the UE.

In accordance with an exemplary embodiment, the one or more actions performed by the UE may further comprise: receiving, from at least one of the one or more other UEs, an acknowledgement indicating that the second indication is received by the at least one of the one or more other UEs. In accordance with another exemplary embodiment, the one or more actions performed by the UE may further comprise: receiving, from at least one of the one or more other UEs, a message indicating that the at least one of the one or more other UEs accepts or rejects the activation or the deactivation of the SL carrier, etc.

In accordance with an exemplary embodiment, the activation or the deactivation of the SL carrier may be performed by the UE, e.g., when receiving, from at least one of the one or more other UEs, an acknowledgement indicating that the second indication is received by the at least one of the one or more other UEs. In accordance with another exemplary embodiment, the activation or the deactivation of the SL carrier may be performed by the UE, e.g., when receiving, from at least one of the one or more other UEs, a message indicating that the at least one of the one or more other UEs accepts the activation or the deactivation of the SL carrier, etc.

In accordance with an exemplary embodiment, the activation or the deactivation of the SL carrier as described with respect to FIG. 3 may be applicable for a direction from the UE to a peer UE of the UE.

In accordance with an exemplary embodiment, the UE may transmit information about the SL carrier to a base station and/or a peer UE of the UE. In an embodiment, the information about the SL carrier may be used by the base station and/or the peer UE of the UE to determine whether to activate or deactivate the SL carrier.

In accordance with an exemplary embodiment, the transmission of the information about the SL carrier may be performed by the UE periodically and/or event triggered. Alternatively or additionally, the transmission of the information about the SL carrier may be performed by the UE, upon reception of a request from the peer UE of the UE, and/or upon reception of signaling from the base station.

In accordance with an exemplary embodiment, the information about the SL carrier may comprise one or more of:
buffer status for all services or for one or more services which are mapped to the SL carrier;
buffer status of current data;
buffer status of future data which is expected to come;
resource status of the SL carrier;
channel measurement information; and
a preference of power saving.

In accordance with an exemplary embodiment, the UE may receive information about the SL carrier from a peer UE of the UE. In an embodiment, the information about the SL carrier may be used by the UE to determine whether to activate or deactivate the SL carrier.

In accordance with an exemplary embodiment, the UE may be configured with a timer for the SL carrier. In this case, the UE may perform various actions for the timer as those described with respect to the UE according to the method 100. For example, the UE may start, restart or stop the timer according to different requirements and application scenarios.

In accordance with an exemplary embodiment, the activation or the deactivation of the SL carrier as described with respect to FIG. 3 may be applicable for transmission on the SL carrier, or for reception on the SL carrier, or for both.

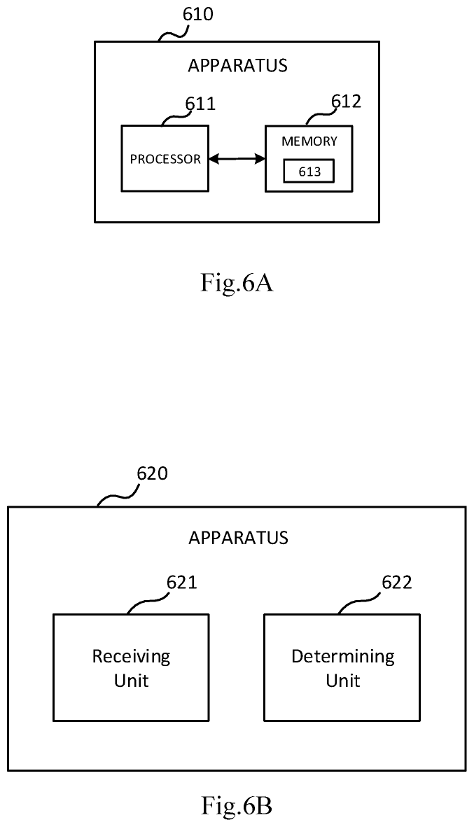

FIG. 4 is a flowchart illustrating a method 400 according to some embodiments of the present disclosure. The method 400 illustrated in FIG. 4 may be performed by a UE or an apparatus communicatively coupled to the UE. In accordance with an exemplary embodiment, the UE may be configured to support D2D communication (e.g., V2X or SL communication, etc.) with other devices. In an exemplary embodiment, the UE may be configured to communicate with a network node (e.g., a base station such as gNB, etc.) directly or via a relay UE.

According to the exemplary method 400 illustrated in FIG. 4, the UE may receive, from a peer UE of the UE (e.g., from the UE as described with respect to FIG. 1 and FIG. 3), an indication of activating or deactivating a SL carrier which is configured for the UE and the peer UE of the UE, as shown in block 402.

In accordance with an exemplary embodiment, the indication of activating or deactivating the SL carrier may comprise: an identifier of the SL carrier; and/or an indicator which indicates that the SL carrier needs to be activated or deactivated, etc. In an embodiment, the indicator which indicates that the SL carrier needs to be activated or deactivated may be a bit associated with the SL carrier in a bitmap.

In accordance with an exemplary embodiment, the UE may be associated with a destination identifier which is associated with the SL carrier. In an embodiment, the destination identifier may be determined by the peer UE itself. In another embodiment, the destination identifier may be indicated to the peer UE by a base station (e.g., the base station as described with respect to FIG. 2).

In accordance with an exemplary embodiment, the UE may transmit, to a base station, a notification of that the SL carrier is to be activated or deactivated. In an embodiment, the UE may receive, from the base station, an instruction of accepting or rejecting the activation or the deactivation of the SL carrier.

According to the exemplary method 400 illustrated in FIG. 4, the UE may optionally determine whether to accept or reject the activation or the deactivation of the SL carrier, in response to the reception of the indication of activating or deactivating the SL carrier, as shown in block 404.

In accordance with an exemplary embodiment, the determination of whether to accept or reject the activation or the deactivation of the SL carrier may be made by the UE itself. In accordance with another exemplary embodiment, the determination of whether to accept or reject the activation or the deactivation of the SL carrier may be made by the UE according to an instruction to the UE, by a base station, of accepting or rejecting the activation or the deactivation of the SL carrier.

In accordance with an exemplary embodiment, the UE may transmit, to its peer UE, an acknowledgement indicating that the indication of activating or deactivating the SL carrier is received by the UE. Alternatively or additionally, the UE may transmit, to its peer UE, a message indicating that the UE accepts or rejects the activation or the deactivation of the SL carrier.

In accordance with an exemplary embodiment, the activation or the deactivation of the SL carrier as described with respect to FIG. 4 may be applicable for a direction from the peer UE of the UE to the UE.

In accordance with an exemplary embodiment, the UE may determine whether to activate or deactivate the SL carrier for a direction from the UE to the peer UE of the UE.

In accordance with an exemplary embodiment, the UE may receive information about the SL carrier from the peer UE of the UE. In an embodiment, the information about the SL carrier may be used by the UE to determine whether to activate or deactivate the SL carrier.

In accordance with an exemplary embodiment, the information about the SL carrier may comprise one or more of:
buffer status for all services or for one or more services which are mapped to the SL carrier;
buffer status of current data;
buffer status of future data which is expected to come;
resource status of the SL carrier;
channel measurement information; and
a preference of power saving.

In accordance with an exemplary embodiment, the UE may transmit information about the SL carrier to a base station and/or the peer UE of the UE. In an embodiment, the information about the SL carrier may be used by the base station and/or the peer UE of the UE to determine whether to activate or deactivate the SL carrier.

In accordance with an exemplary embodiment, the transmission of the information about the SL carrier may be performed by the UE periodically and/or event triggered. Alternatively or additionally, the transmission of the information about the SL carrier may be performed by the UE, upon reception of a request from the peer UE of the UE, and/or upon reception of signaling from the base station.

In accordance with an exemplary embodiment, when the UE is configured with a timer for the SL carrier, the UE may perform one or more of the following actions:
starting the timer upon the activation of the SL carrier;
restarting the timer in response to one or more events;
starting to deactivate the SL carrier when the timer is expired; and
stopping the timer when the UE starts to deactivate the SL carrier.

In accordance with an exemplary embodiment, the one or more events may comprise one or more of:
reception of DCI indicating one or more SL grants for the SL carrier by the UE;
transmission of a MAC PDU on the SL carrier by the UE in a configured SL grant;
transmission of SCI on the SL carrier after the UE obtains a SL grant; and
reception of SCI on the SL carrier by the UE indicating a coming reception from the peer UE of the UE.

In accordance with an exemplary embodiment, the activation or the deactivation of the SL carrier as described with respect to FIG. 4 may be applicable for transmission on the SL carrier, or for reception on the SL carrier, or for both.

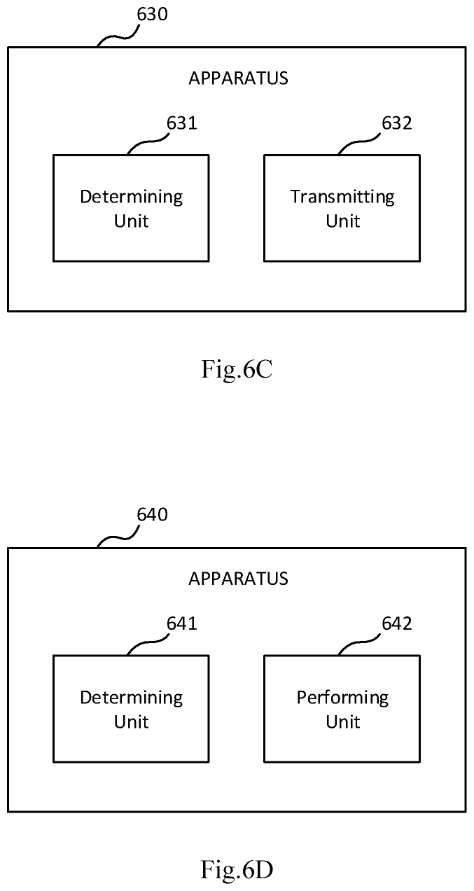

FIG. 5 is a flowchart illustrating a method 500 according to some embodiments of the present disclosure. The method 500 illustrated in FIG. 5 may be performed by a base station (e.g., a gNB, an AP, etc.) or an apparatus communicatively coupled to the base station. In accordance with an exemplary embodiment, the base station may be configured to support cellular coverage extension with D2D communication (e.g., V2X or SL communication, etc.). In an exemplary embodiment, the base station may be configured to communicate with a terminal device such as a UE, e.g. directly or via a relay UE.

According to the exemplary method 500 illustrated in FIG. 5, the base station may receive, from a UE (e.g., the UE as described with respect to FIG. 4), a notification of that a SL carrier configured for the UE and a peer UE of the UE is to be activated or deactivated, as shown in block 502. In accordance with an exemplary embodiment, the base station may transmit, to the UE, an instruction of accepting or rejecting activation or deactivation of the SL carrier, as shown in block 504.

In accordance with an exemplary embodiment, the UE may be associated with a destination identifier which is associated with the SL carrier. In an embodiment, the destination identifier may be determined by the peer UE of the UE (e.g., according to the method 300 as described with respect to FIG. 3) and/or by another base station serving the peer UE of the UE (e.g., according to the method 100 as described with respect to FIG. 1).

In accordance with an exemplary embodiment, the activation or the deactivation of the SL carrier as described with respect to FIG. 5 may be applicable for a direction from the peer UE of the UE to the UE.

In accordance with an exemplary embodiment, the base station may receive information about the SL carrier from the UE. In an embodiment, the information about the SL carrier may be used by the base station to determine whether to activate or deactivate the SL carrier.

In accordance with an exemplary embodiment, the information about the SL carrier may comprise: buffer status for all services or for one or more services which are mapped to the SL carrier; buffer status of current data; buffer status of future data which is expected to come; resource status of the SL carrier; channel measurement information; and/or a preference of power saving, etc.

In accordance with an exemplary embodiment, the activation or the deactivation of the SL carrier as described with respect to FIG. 5 may be applicable for transmission on the SL carrier, or for reception on the SL carrier, or for both.

In accordance with an exemplary embodiment, the base station may exchange information with one or more other base stations to determine whether to accept or reject the activation or the deactivation of the SL carrier.

It can be appreciated that the UE as described with respect to FIG. 1 may also be configured to perform the method 300 as described with respect to FIG. 3 and/or the method 400 as described with respect to FIG. 4, according to different application scenarios and service requirements.

Similarly, it can be appreciated that the UE as described with respect to FIG. 3 may also be configured to perform the method 100 as described with respect to FIG. 1 and/or the method 400 as described with respect to FIG. 4, according to different application scenarios and service requirements.

Similarly, it can be appreciated that the UE as described with respect to FIG. 4 may also be configured to perform the method 100 as described with respect to FIG. 1 and/or the method 300 as described with respect to FIG. 3, according to different application scenarios and service requirements.

It also can be appreciated that the base station as described with respect to FIG. 2 may also be configured to perform the method 500 as described with respect to FIG. 5, according to different application scenarios and service requirements. Similarly, it can be appreciated that the base station as described with respect to FIG. 5 may also be configured to perform the method 200 as described with respect to FIG. 2, according to different application scenarios and service requirements.

The various blocks shown in FIGS. 1-5 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

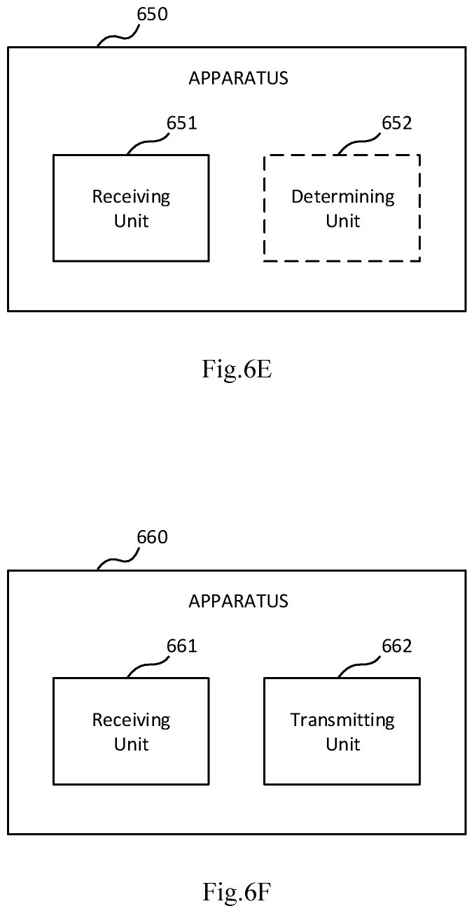

FIG. 6A is a block diagram illustrating an apparatus 610 according to various embodiments of the present disclosure. As shown in FIG. 6A, the apparatus 610 may comprise one or more processors such as processor 611 and one or more memories such as memory 612 storing computer program codes 613. The memory 612 may be non-transitory machine/processor/computer readable storage medium. In accordance with some exemplary embodiments, the apparatus 610 may be implemented as an integrated circuit chip or module that can be plugged or installed into a UE as described with respect to FIG. 1, a base station as described with respect to FIG. 2, a UE as described with respect to FIG. 3, a UE as described with respect to FIG. 4, or a base station as described with respect to FIG. 5. In such cases, the apparatus 610 may be implemented as a UE as described with respect to FIG. 1, a base station as described with respect to FIG. 2, a UE as described with respect to FIG. 3, a UE as described with respect to FIG. 4, or a base station as described with respect to FIG. 5.

In some implementations, the one or more memories 612 and the computer program codes 613 may be configured to, with the one or more processors 611, cause the apparatus 610 at least to perform any operation of the method as described in connection with FIG. 1. In other implementations, the one or more memories 612 and the computer program codes 613 may be configured to, with the one or more processors 611, cause the apparatus 610 at least to perform any operation of the method as described in connection with FIG. 2. In other implementations, the one or more memories 612 and the computer program codes 613 may be configured to, with the one or more processors 611, cause the apparatus 610 at least to perform any operation of the method as described in connection with FIG. 3. In other implementations, the one or more memories 612 and the computer program codes 613 may be configured to, with the one or more processors 611, cause the apparatus 610 at least to perform any operation of the method as described in connection with FIG. 4. In other implementations, the one or more memories 612 and the computer program codes 613 may be configured to, with the one or more processors 611, cause the apparatus 610 at least to perform any operation of the method as described in connection with FIG. 5. Alternatively or additionally, the one or more memories 612 and the computer program codes 613 may be configured to, with the one or more processors 611, cause the apparatus 610 at least to perform more or less operations to implement the proposed methods according to the exemplary embodiments of the present disclosure.

FIG. 6B is a block diagram illustrating an apparatus 620 according to some embodiments of the present disclosure. As shown in FIG. 6B, the apparatus 620 may comprise a receiving unit 621 and a determining unit 622. In an exemplary embodiment, the apparatus 620 may be implemented in a UE. The receiving unit 621 may be operable to carry out the operation in block 102, and the determining unit 622 may be operable to carry out the operation in block 104. Optionally, the receiving unit 621 and/or the determining unit 622 may be operable to carry out more or less operations to implement the proposed methods according to the exemplary embodiments of the present disclosure.

FIG. 6C is a block diagram illustrating an apparatus 630 according to some embodiments of the present disclosure. As shown in FIG. 6C, the apparatus 630 may comprise a determining unit 631 and a transmitting unit 632. In an exemplary embodiment, the apparatus 630 may be implemented in a base station (e.g., a gNB, etc.). The determining unit 631 may be operable to carry out the operation in block 202, and the transmitting unit 632 may be operable to carry out the operation in block 204. Optionally, the determining unit 631 and/or the transmitting unit 632 may be operable to carry out more or less operations to implement the proposed methods according to the exemplary embodiments of the present disclosure.

FIG. 6D is a block diagram illustrating an apparatus 640 according to some embodiments of the present disclosure. As shown in FIG. 6D, the apparatus 640 may comprise a determining unit 641 and a performing unit 642. In an exemplary embodiment, the apparatus 640 may be implemented in a UE. The determining unit 641 may be operable to carry out the operation in block 302, and the performing unit 642 may be operable to carry out the operation in block 304. Optionally, the determining unit 641 and/or the performing unit 642 may be operable to carry out more or less operations to implement the proposed methods according to the exemplary embodiments of the present disclosure.

FIG. 6E is a block diagram illustrating an apparatus 650 according to some embodiments of the present disclosure. As shown in FIG. 6E, the apparatus 650 may comprise a receiving unit 651 and optionally a determining unit 652. In an exemplary embodiment, the apparatus 650 may be implemented in a UE. The receiving unit 651 may be operable to carry out the operation in block 402, and the determining unit 652 may be operable to carry out the operation in block 404. Optionally, the receiving unit 651 and/or the determining unit 652 may be operable to carry out more or less operations to implement the proposed methods according to the exemplary embodiments of the present disclosure.

FIG. 6F is a block diagram illustrating an apparatus 660 according to some embodiments of the present disclosure. As shown in FIG. 6F, the apparatus 660 may comprise a receiving unit 661 and a transmitting unit 662. In an exemplary embodiment, the apparatus 660 may be implemented in a base station (e.g., a gNB, etc.). The receiving unit 661 may be operable to carry out the operation in block 502, and the transmitting unit 662 may be operable to carry out the operation in block 504. Optionally, the receiving unit 661 and/or the transmitting unit 662 may be operable to carry out more or less operations to implement the proposed methods according to the exemplary embodiments of the present disclosure.

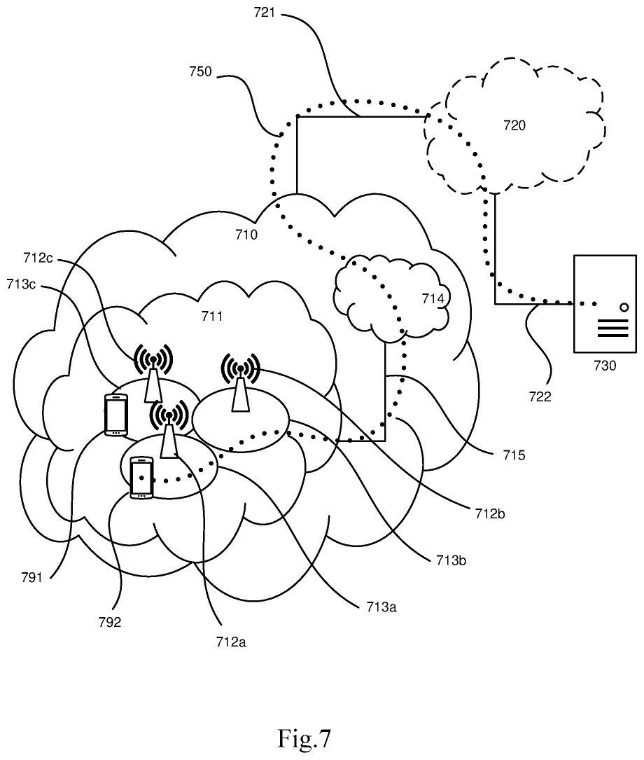

FIG. 7 is a block diagram illustrating a telecommunication network connected via an intermediate network to a host computer in accordance with some embodiments of the present disclosure.

With reference to FIG. 7, in accordance with an embodiment, a communication system includes a telecommunication network 710, such as a 3GPP-type cellular network, which comprises an access network 711, such as a radio access network, and a core network 714. The access network 711 comprises a plurality of base stations 712a, 712b, 712c, such as NBs, eNBs, gNBs or other types of wireless access points, each defining a corresponding coverage area 713a, 713b, 713c. Each base station 712a, 712b, 712c is connectable to the core network 714 over a wired or wireless connection 715. A first UE 791 located in a coverage area 713c is configured to wirelessly connect to, or be paged by, the corresponding base station 712c. A second UE 792 in a coverage area 713a is wirelessly connectable to the corresponding base station 712a. While a plurality of UEs 791, 792 are illustrated in this example, the disclosed embodiments are equally applicable to a situation where a sole UE is in the coverage area or where a sole UE is connecting to the corresponding base station 712.

The telecommunication network 710 is itself connected to a host computer 730, which may be embodied in the hardware and/or software of a standalone server, a cloud-implemented server, a distributed server or as processing resources in a server farm. The host computer 730 may be under the ownership or control of a service provider, or may be operated by the service provider or on behalf of the service provider. Connections 721 and 722 between the telecommunication network 710 and the host computer 730 may extend directly from the core network 714 to the host computer 730 or may go via an optional intermediate network 720. An intermediate network 720 may be one of, or a combination of more than one of, a public, private or hosted network; the intermediate network 720, if any, may be a backbone network or the Internet; in particular, the intermediate network 720 may comprise two or more sub-networks (not shown).

The communication system of FIG. 7 as a whole enables connectivity between the connected UEs 791, 792 and the host computer 730. The connectivity may be described as an over-the-top (OTT) connection 750. The host computer 730 and the connected UEs 791, 792 are configured to communicate data and/or signaling via the OTT connection 750, using the access network 711, the core network 714, any intermediate network 720 and possible further infrastructure (not shown) as intermediaries. The OTT connection 750 may be transparent in the sense that the participating communication devices through which the OTT connection 750 passes are unaware of routing of uplink and downlink communications. For example, the base station 712 may not or need not be informed about the past routing of an incoming downlink communication with data originating from the host computer 730 to be forwarded (e.g., handed over) to a connected UE 791. Similarly, the base station 712 need not be aware of the future routing of an outgoing uplink communication originating from the UE 791 towards the host computer 730.

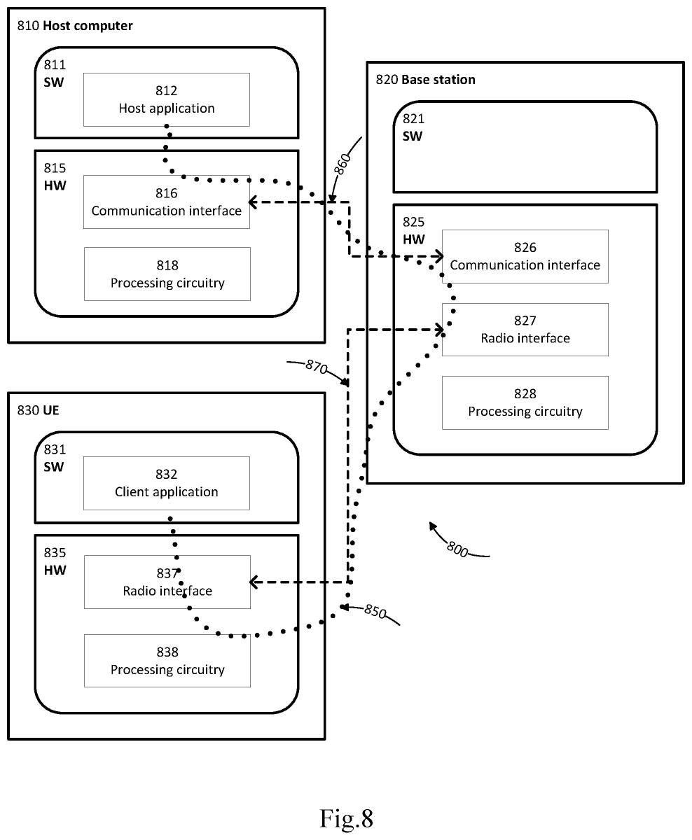

FIG. 8 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 8. In a communication system 800, a host computer 810 comprises hardware 815 including a communication interface 816 configured to set up and maintain a wired or wireless connection with an interface of a different communication device of the communication system 800. The host computer 810 further comprises a processing circuitry 818, which may have storage and/or processing capabilities. In particular, the processing circuitry 818 may comprise one or more programmable processors, application-specific integrated circuits, field programmable gate arrays or combinations of these (not shown) adapted to execute instructions. The host computer 810 further comprises software 811, which is stored in or accessible by the host computer 810 and executable by the processing circuitry 818. The software 811 includes a host application 812. The host application 812 may be operable to provide a service to a remote user, such as UE 830 connecting via an OTT connection 850 terminating at the UE 830 and the host computer 810. In providing the service to the remote user, the host application 812 may provide user data which is transmitted using the OTT connection 850.

The communication system 800 further includes a base station 820 provided in a telecommunication system and comprising hardware 825 enabling it to communicate with the host computer 810 and with the UE 830. The hardware 825 may include a communication interface 826 for setting up and maintaining a wired or wireless connection with an interface of a different communication device of the communication system 800, as well as a radio interface 827 for setting up and maintaining at least a wireless connection 870 with the UE 830 located in a coverage area (not shown in FIG. 8) served by the base station 820. The communication interface 826 may be configured to facilitate a connection 860 to the host computer 810. The connection 860 may be direct or it may pass through a core network (not shown in FIG. 8) of the telecommunication system and/or through one or more intermediate networks outside the telecommunication system. In the embodiment shown, the hardware 825 of the base station 820 further includes a processing circuitry 828, which may comprise one or more programmable processors, application-specific integrated circuits, field programmable gate arrays or combinations of these (not shown) adapted to execute instructions. The base station 820 further has software 821 stored internally or accessible via an external connection.

The communication system 800 further includes the UE 830 already referred to. Its hardware 835 may include a radio interface 837 configured to set up and maintain a wireless connection 870 with a base station serving a coverage area in which the UE 830 is currently located. The hardware 835 of the UE 830 further includes a processing circuitry 838, which may comprise one or more programmable processors, application-specific integrated circuits, field programmable gate arrays or combinations of these (not shown) adapted to execute instructions. The UE 830 further comprises software 831, which is stored in or accessible by the UE 830 and executable by the processing circuitry 838. The software 831 includes a client application 832. The client application 832 may be operable to provide a service to a human or non-human user via the UE 830, with the support of the host computer 810. In the host computer 810, an executing host application 812 may communicate with the executing client application 832 via the OTT connection 850 terminating at the UE 830 and the host computer 810. In providing the service to the user, the client application 832 may receive request data from the host application 812 and provide user data in response to the request data. The OTT connection 850 may transfer both the request data and the user data. The client application 832 may interact with the user to generate the user data that it provides.

It is noted that the host computer 810, the base station 820 and the UE 830 illustrated in FIG. 8 may be similar or identical to the host computer 730, one of base stations 712a, 712b, 712c and one of UEs 791, 792 of FIG. 7, respectively. This is to say, the inner workings of these entities may be as shown in FIG. 8 and independently, the surrounding network topology may be that of FIG. 7.

In FIG. 8, the OTT connection 850 has been drawn abstractly to illustrate the communication between the host computer 810 and the UE 830 via the base station 820, without explicit reference to any intermediary devices and the precise routing of messages via these devices. Network infrastructure may determine the routing, which it may be configured to hide from the UE 830 or from the service provider operating the host computer 810, or both. While the OTT connection 850 is active, the network infrastructure may further take decisions by which it dynamically changes the routing (e.g., on the basis of load balancing consideration or reconfiguration of the network).

Wireless connection 870 between the UE 830 and the base station 820 is in accordance with the teachings of the embodiments described throughout this disclosure. One or more of the various embodiments improve the performance of OTT services provided to the UE 830 using the OTT connection 850, in which the wireless connection 870 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 850 between the host computer 810 and the UE 830, in response to variations in the measurement results. The measurement procedure and/or the network functionality for reconfiguring the OTT connection 850 may be implemented in software 811 and hardware 815 of the host computer 810 or in software 831 and hardware 835 of the UE 830, or both. In embodiments, sensors (not shown) may be deployed in or in association with communication devices through which the OTT connection 850 passes; the sensors may participate in the measurement procedure by supplying values of the monitored quantities exemplified above, or supplying values of other physical quantities from which the software 811, 831 may compute or estimate the monitored quantities. The reconfiguring of the OTT connection 850 may include message format, retransmission settings, preferred routing etc.; the reconfiguring need not affect the base station 820, and it may be unknown or imperceptible to the base station 820. Such procedures and functionalities may be known and practiced in the art. In certain embodiments, measurements may involve proprietary UE signaling facilitating the host computer 810's measurements of throughput, propagation times, latency and the like. The measurements may be implemented in that the software 811 and 831 causes messages to be transmitted, in particular empty or ‘dummy’ messages, using the OTT connection 850 while it monitors propagation times, errors etc.

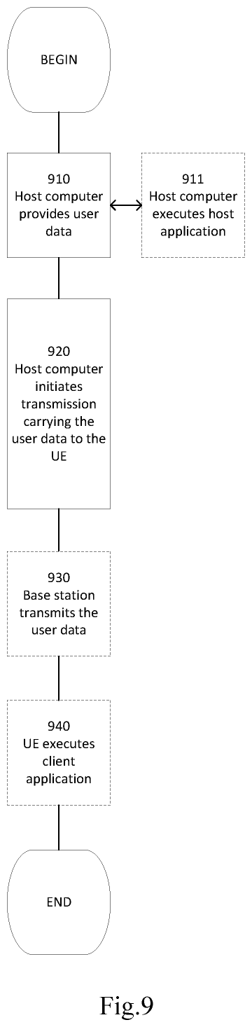

FIG. 9 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 9 will be included in this section. In step 910, the host computer provides user data. In substep 911 (which may be optional) of step 910, the host computer provides the user data by executing a host application. In step 920, the host computer initiates a transmission carrying the user data to the UE. In step 930 (which may be optional), the base station transmits to the UE the user data which was carried in the transmission that the host computer initiated, in accordance with the teachings of the embodiments described throughout this disclosure. In step 940 (which may also be optional), the UE executes a client application associated with the host application executed by the host computer.

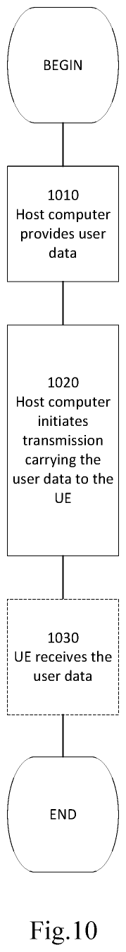

FIG. 10 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 10 will be included in this section. In step 1010 of the method, the host computer provides user data. In an optional substep (not shown) the host computer provides the user data by executing a host application. In step 1020, the host computer initiates a transmission carrying the user data to the UE. The transmission may pass via the base station, in accordance with the teachings of the embodiments described throughout this disclosure. In step 1030 (which may be optional), the UE receives the user data carried in the transmission.

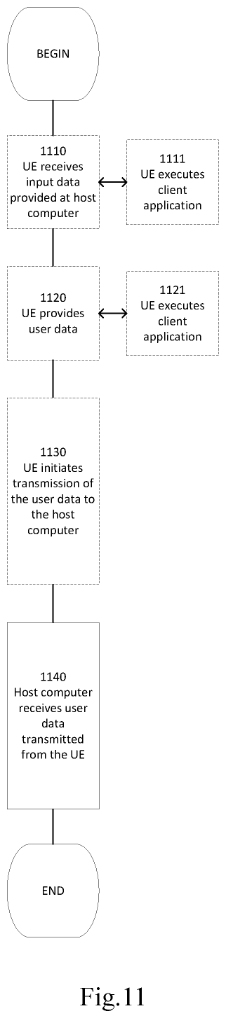

FIG. 11 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 11 will be included in this section. In step 1110 (which may be optional), the UE receives input data provided by the host computer. Additionally or alternatively, in step 1120, the UE provides user data. In substep 1121 (which may be optional) of step 1120, the UE provides the user data by executing a client application. In substep 1111 (which may be optional) of step 1110, the UE executes a client application which provides the user data in reaction to the received input data provided by the host computer. In providing the user data, the executed client application may further consider user input received from the user. Regardless of the specific manner in which the user data was provided, the UE initiates, in substep 1130 (which may be optional), transmission of the user data to the host computer. In step 1140 of the method, the host computer receives the user data transmitted from the UE, in accordance with the teachings of the embodiments described throughout this disclosure.

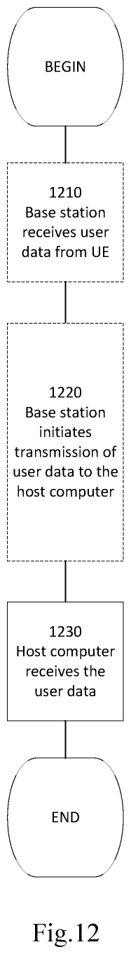

FIG. 12 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 12 will be included in this section. In step 1210 (which may be optional), in accordance with the teachings of the embodiments described throughout this disclosure, the base station receives user data from the UE. In step 1220 (which may be optional), the base station initiates transmission of the received user data to the host computer. In step 1230 (which may be optional), the host computer receives the user data carried in the transmission initiated by the base station.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the exemplary method 200 as described with respect to FIG. 2, or any step of the exemplary method 500 as described with respect to FIG. 5.

According to some exemplary embodiments, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the exemplary method 200 as described with respect to FIG. 2, or any step of the exemplary method 500 as described with respect to FIG. 5.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the exemplary method 100 as described with respect to FIG. 1, or any step of the exemplary method 300 as described with respect to FIG. 3, or any step of the exemplary method 400 as described with respect to FIG. 4.

According to some exemplary embodiments, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the exemplary method 100 as described with respect to FIG. 1, or any step of the exemplary method 300 as described with respect to FIG. 3, or any step of the exemplary method 400 as described with respect to FIG. 4.

According to some exemplary embodiments, there is provided a method implemented in a communication system which may include a host computer, a base station and a UE. The method may comprise, at the host computer, receiving user data transmitted to the base station from the UE which may perform any step of the exemplary method 100 as described with respect to FIG. 1, or any step of the exemplary method 300 as described with respect to FIG. 3, or any step of the exemplary method 400 as described with respect to FIG. 4.

According to some exemplary embodiments, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the exemplary method 100 as described with respect to FIG. 1, or any step of the exemplary method 300 as described with respect to FIG. 3, or any step of the exemplary method 400 as described with respect to FIG. 4.

According to some exemplary embodiments, there is provided a method implemented in a communication system which may include a host computer, a base station and a UE. The method may comprise, at the host computer, receiving, from the base station, user data originating from a transmission which the base station has received from the UE. The base station may perform any step of the exemplary method 200 as described with respect to FIG. 2, or any step of the exemplary method 500 as described with respect to FIG. 5.

According to some exemplary embodiments, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the exemplary method 200 as described with respect to FIG. 2, or any step of the exemplary method 500 as described with respect to FIG. 5.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1.-88. (canceled)

89. A method performed by a user equipment (UE), the method comprising:
receiving, from a base station, a first indication of activating or deactivating a sidelink (SL) carrier configured for the UE and for one or more other UEs;
determining whether to activate or deactivate the SL carrier, according to the first indication; and
transmitting a second indication of activating or deactivating the SL carrier to the one or more other UEs that are configured with the SL carrier.

90. The method of claim 89, wherein the first indication comprises one or more of the following information:
an identifier of the SL carrier;
an indicator that indicates the SL carrier needs to be activated or deactivated;
one or more destination identifiers associated with the SL carrier; and
one or more factors that, when satisfied, indicate the SL carrier needs to be activated or deactivated.

91. The method of claim 90, wherein the one or more factors comprise one or more of the following:
a time threshold indicating a time period during which the SL carrier needs to be deactivated;
a buffer threshold above which the SL carrier needs to be activated;
timing of activating the SL carrier; and
timing of deactivating the SL carrier.

92. The method of claim 90, wherein the indicator that indicates the SL carrier needs to be activated or deactivated is a bit in a bitmap, wherein the bit is associated with the SL carrier.

93. The method of claim 90, wherein when the first indication comprises the one or more factors, determining whether to activate or deactivate the SL carrier is based at least in part on the one or more factors.

94. The method of claim 90, wherein the one or more other UEs are associated with the respective one or more destination identifiers.

95. The method of claim 89, wherein the method further comprises, when it determined to activate the SL carrier, activating the SL carrier according to the first indication.

96. The method of claim 95, wherein a timing of activating the SL carrier is based at least in part on the first indication.

97. The method of claim 89, wherein the method further comprises, when it determined to deactivate the SL carrier, deactivating the SL carrier according to the first indication.

98. The method of claim 97, wherein deactivating the SL carrier comprises one or more of the following:
clearing any mode 2 SL grant associated with the SL carrier;
stopping sensing on the SL carrier if the UE adopts mode 2 resource allocation;
stopping SL transmission on the SL carrier; and
stopping SL reception on the SL carrier.

99. The method of claim 89, wherein the second indication comprises one or more of the following information:
an identifier of the SL carrier; and
an indicator that indicates the SL carrier needs to be activated or deactivated.

100. The method of claim 89, further comprising receiving one or more of the following information from at least one of the one or more other UEs:
respective acknowledgements that the second indication was received by the at least one other UE; and
respective messages indicating that the at least one other UE accepts or rejects the activation or the deactivation of the SL carrier.

101. The method of claim 100, further comprising activating or deactivating the SL carrier based on the information received from the at least one other UE.

102. The method of claim 89, further comprising receiving information about the SL carrier from a peer UE of the UE, wherein determining whether to activate or deactivate the SL carrier is further based on the received information.

103. A user equipment (UE) comprising:
one or more processors; and
one or more memories comprising computer program code executable by the one or more processors, wherein execution of the computer program code by the one or more processors causes the UE to:
receive, from a base station, a first indication of activating or deactivating a sidelink (SL) carrier configured for the UE and for one or more other UEs;
determine whether to activate or deactivate the SL carrier, according to the first indication; and
transmit a second indication of activating or deactivating the SL carrier to the one or more other UEs that are configured with the SL carrier.

104. The UE of claim 103, wherein the first indication comprises one or more of the following information:
an identifier of the SL carrier;
an indicator that indicates the SL carrier needs to be activated or deactivated;
one or more destination identifiers associated with the SL carrier; and
one or more factors that, when satisfied, indicate the SL carrier needs to be activated or deactivated.

105. The UE of claim 104, wherein the one or more factors comprise one or more of the following:
a time threshold indicating a time period during which the SL carrier needs to be deactivated;
a buffer threshold above which the SL carrier needs to be activated;
timing of activating the SL carrier; and
timing of deactivating the SL carrier.

106. A method performed by a base station, the method comprising:
determining a first indication of activating or deactivating a sidelink (SL) carrier configured for a user equipment (UE) and for one or more other UEs; and
transmitting the first indication to the UE, wherein the first indication causes the UE to transmit a second indication of activating or deactivating the SL carrier to the one or more other UEs that are configured with the SL carrier.

107. The method of claim 106, wherein the first indication comprises one or more of the following information:
an identifier of the SL carrier;
an indicator which indicates that the SL carrier needs to be activated or deactivated;
one or more destination identifiers associated with the SL carrier; and
one or more factors, wherein when the one or more factors are satisfied, the SL carrier needs to be activated or deactivated.

108. A base station, comprising:
one or more processors; and
one or more memories comprising computer program code executable by the one or more processors, wherein execution of the computer program code by the one or more processors causes the base station to perform the method of claim 106.
